(19) United States
(12) Patent Application Publication
(10) Pub. No.: US 2019/0139170 A1
(43) Pub. Date: May 9, 2019

(54) Delivering Internet Content

(71) Applicant: PulsePoint, Inc., New York, NY (US)

(72) Inventors: Anand Subramanian, New York, NY (US); Shanthi Sarkar, New York, NY (US)

(73) Assignee: PulsePoint, Inc., New York, NY (US)

(21) Appl. No.: 15/375,336

(22) Filed: Dec. 12, 2016

(51) Int. Cl. G06Q 50/18; G06Q 20/08; G06Q 30/02

(52) U.S. Cl. CPC G06Q 50/188; G06Q 30/0257; G06Q 20/085

(57) ABSTRACT

A method for an exchange computer system. Supply data are received from one or more internet publishers, the supply data specifying media space to be supplied to content providers for delivery of the providers' content at future times by respective supplying publishers and compensated in per-delivery charges as respective supplying publishers deliver providers' content over the internet. Request data are received from one or more content providers, the request data specifying requests to acquire media for subsequent display of providers' content, and storing the request data into the memory of the exchange computer. The request data are matched against the supply data to form respective contracts between publishers and content providers for delivery of internet content, and compensation in per-delivery charges as contracted publishers deliver the contracted content providers' content over the internet.

This application is a continuation of U.S. application Ser. No. 12/507,513, filed Jul. 22, 2009, titled “New Open Insertion Order System to Interface with an Exchange for Internet Ad Media,” incorporated by reference. The '513 application is a non-provisional of U.S. Provisional Application No. 61/082,676, filed on Jul. 22, 2008 and entitled “New Open Insertion Order System To Interface With An Exchange For Internet Ad Media.” U.S. application Ser. No. 12/507,513 is a continuation-in-part of U.S. application Ser. No. 11/933,187, filed on Oct. 31, 2007, titled “Online Exchange For Internet Ad Media,” which is a continuation-in-part of U.S. application Ser. No. 11/627,902, filed on Jan. 26, 2007, titled “System and Method for Operating A Marketplace For Internet Ad Media And For Delivering Ads According to Traded Made in That Marketplace,” which is a non-provisional of U.S. Provisional Application No. 60/762,980, filed on Jan. 26, 2006 and entitled “System and Method for Operating a Marketplace for Internet Ad Media and for Delivering Ads According to Traded Made in That Marketplace,” each of which is hereby incorporated by reference in its entirety.

This application relates to delivery of internet content.

### BACKGROUND

Standard producers of online ad-request inventory are publishers. They own or operate websites that users visit using web browsers, and they allocate space on those pages where advertisements may be added. Consumers of online ad-request inventory are Advertisers. They offer products or services online, and they create advertisements for those offerings which they desire to show to Internet users. Those advertisements are then added into the publishers' pages so that users see them as they browse. Each time an individual user browses to a publishers' page that contains pre-allocated space for advertising, an Ad Request to deliver an ad to fill that allocated space can be made to an Ad Server either by the user's browser or by the Publisher.

Publishers are able to predict in advance approximately how many times in a given day or month a user will browse (or request to view) one of the pages on their site. By combining this prediction with the knowledge of which page spaces have been set aside for advertisements, Publishers can estimate how many advertisements will be shown to users visiting their site in a given period of time. The accuracy of this estimate depends on such factors as the publisher, its typical volume of user page views, behavioral patterns of that user base, and the granularity of the analysis, and other factors that serve as a metric of activity. Because Publishers are paid for allowing parts of their pages to be filled with advertisements, this estimate of future ads to be shown may be considered an asset owned by that Publisher. As with any other asset, this asset can be sold to advertisers or their agents. The asset can be called an Ad Request Inventory or Ad Media. Advertisers and/or their agents who buy this inventory may be called media buyers. Publishers and/or their agents who sell this inventory may be called media sellers.

When the Ad Media is considered in terms of the number of expected ad requests, the inventory is typically quantified as a particular number of Ad Impressions. Ad Impressions are priced as a Cost-Per-Thousand Impressions (“CPM”). Additionally, because a click may or may not result each time an ad is shown to a user, inventory may also be quantified as a particular number of expected Ad Clicks, and could be priced as a Cost-Per-Click (“CPC”). Inventory also may be quantified and priced in other standard ways known to those in the relevant art, such as a number of Conversions and a Cost-Per-Action (“CPA”) which measures the advertising cost per users who purchase or subscribe to the advertised product or service.

Prior to buying Ad Media, i.e., advertising space on a webpage, media buyers place their advertisements into a specialized system called an Ad Server. An Ad Server selectively delivers one or more of the ads placed by the media buyer in response to requests made to the Ad Server. The Ad Server provides the Media Buyer with a small piece of industry-standard software called an Ad Tag. Upon its execution, the Ad Tag sends a request to the ad server to deliver one or more of the media buyer's ads.

When media buyers buy Ad Media they often provide the same Ad Tag, or a slightly modified version, to the media seller and/or publisher. The media seller assures that the Ad Tag is executed according to the contracted terms of the sale, i.e., user geographic locations, time of day, specified date range (“flight dates”), quantity, and other parameters. Among these contracted terms may be a categorization of the pages where the ads are to be shown. Categorization allows media buyers to buy Ad Media across a group of publishers on the basis of a number of impressions, or clicks, etc., in particular a category or categories. For example, a bank wishing to advertise its mortgage programs can restrict the display of its ads only to pages categorized as Finance-related, or Home Finance-related. Targeting an ad placement in this manner allows media buyers to spend ad budgets more efficiently. Also Ad Media is not wasted showing unrelated ads.

When advertisers purchase distribution for their ads on a website or set of websites, there are a few standard ways they can pay for that. The simplest models are:
1. A fixed cost per thousand impressions (“CPM model”). If an advertiser pays a fixed rate CPM (e.g., $1.00), they pay the fixed rate of $1 for every thousand times their ad is shown (impression), regardless of user response rate to that ad.
2. A fixed cost-per-click model (“CPC”). If an advertiser pays a fixed rate (e.g., $1) CPC, they pay $1 every time a user clicks on that ad, regardless of the number of times the ad is shown without being clicked.
3. A fixed cost-per-action model (“CPA”). If an advertiser pays a fixed rate (e.g. $5), they pay $5 every time a user either purchases the product being advertised, or signs up for the service being advertised, or takes whatever positive action being advertised for users to take, regardless of the number of ad impressions or clicks.

However in many situations the market value of ad space may vary. For example, if the ad is to be matched to a keyword on an active search page or in contextual advertising, then the value of that ad space depends on the market value for that keyword (e.g., “casino” is typically more valuable for advertising than “paper”).

As a result, auction models have become common. In such a case advertisers bid on how much they're willing to pay—typically on a CPC basis—to have their ad shown on those pages, against that keyword or context, etc. An ad server implements the placement algorithm and is able to maximize the value of that ad space by selecting the highest paying ads at any given time. In some cases the ad server will also combine performance data for that ad (including click-through-rate (“CTR”) data, for example) with the bid price per click to determine the effective CPM (“eCPM”) rate for each ad, and then choose the highest eCPM ads. The eCPM may also be combined with purchase or other conversion data to establish a cost per action (“CPA”), and then include CPA values in the selection process. In either case the ad selection formula typically relies on an auction-based marketplace. The term eCPM is an industry standard known to persons of ordinary skill in the art. As is readily understood by a person of ordinary skill in the art, CPA is also known as cost-per-conversion, or cost-per-sale.

The eCPM value reflects what the equivalent CPM is if the pricing model is based on CPC or some other non-CPM model. For example, a CPC rate multiplied by the ad's click-through rate multiplied by 1000 yields the eCPM for that ad based on its response.

$$eCPM = CPC \times CTR \times 1 , 000$$

$$or$$

$$eCPM = \frac{Cost}{Click} \times \frac{Click}{Impression} \times 1 , 000$$

Further insight into these topics can be found in U.S. patent application Ser. No. 11/502,751, titled “Method and System for Placement and Pricing of Internet-Based Advertisements or Services,” filed Aug. 11, 2006 with common inventors and assigned to the same entity as the present invention. U.S. patent application Ser. No. 11/502,751 is hereby incorporated by reference in its entirety.

The ability to buy and sell media by category is a feature of the current online advertising market. Categorization adds value, and makes it possible for media sellers to demand higher prices (e.g., CPM or CPC). The demand for well categorized media implies demand for scalable categorization processes. Prior art processes include both manual and automated approaches. A manual approach has human editors reviewing publishers' sites to categorize the whole site, either to a particular category, or to categorize different areas of the site to various different categories. This process can easily become labor intensive requiring a large number of human editors. This approach quickly becomes untenable on pages that contain dynamic content—e.g., online newspapers or blogs where content or stories might be different subjects on different days. For dynamic content, human editors cannot logistically keep up with re-reading these pages' content and changing their categorization decisions.

U.S. Published Patent Application No. 2002-0123912-A1, titled “Internet Contextual Communication System” to Subramanian et al., automates approaches for media categorization that are more scalable for both static content and dynamic content situations. However, even with effective automated categorization systems, the burden remains on media sellers to choose among the available automated and manual approaches. This choice results in the presence of a confusing mix of approaches in the advertising market. Therefore, further increasing the burden on media buyers to work with a multitude of approaches and manage quantities of inventory bought from each seller in each model. U.S. Published Patent Application No. 2002-0123912-A1 is hereby incorporated by reference in its entirety.

Another problem present in the prior art models affects the media buyers' experience in monitoring the performance of their media buys. In order to monitor the effectiveness of their media buys, media buyers receive regular reports on the number of ad impressions, clicks, and/or conversions, etc. delivered each day, month, etc. However, for media buys that are not site specific, media sellers rarely if ever report which particular Publishers' sites ran the media buyer's ads. Oftentimes within a media-buy there are some Publishers' sites where the ads are effective, and some sites where the ads are ineffective. Similarly within an uncategorized or run-of-network media-buy there will often be one or more categories that are effective and one or more that are ineffective. Even within a categorized media-buy there will often be one or more sub-categories that are relatively effective, and one or more that are relatively ineffective. However, media buyers have no mechanism to determine which part of their buys are the effective parts. Additionally, even if the effective buy parts are known, media buyers can not act on that knowledge because media often cannot be bought at the next level of granularity (e.g., sub-category level or site-specific).

Missing from the art is a mechanism to create a standardized marketplace where parties can meet to buy and sell media according to free-market prices and a standard categorization approach. The present invention can satisfy one or more of these and other needs.

Agencies have issues with their campaigns under delivering. When a media buy on the plan under delivers, Agencies scramble at the end of the campaign to try and fill the budget by making spot buys from other sources. This requires manual monitoring and intervention by media buyers at Agencies. As a result, the trading of Internet ad media is currently a burdensome and inefficient series of sequential negotiations between buyers and sellers, or their representatives. Often, when the Agencies do not catch the under delivery on time, a lot of money is left on the table if they are not able to find another source to fill the under delivery. It would be desirable for a system, method, or program to provide for an automated filling of ad media in the delivery shortfall of other media buys on the plan with inventory from the exchange.

### SUMMARY

In general, in one aspect, a system will monitor the delivery of identified advertising campaigns and fill instances of under delivery with impressions from the publisher inventory of the exchange. More particularly, advertisers and agencies that make a media buy are able to fulfill their advertising budget in its entirety. In related aspects, the method can be used as an insurance program where if the publisher on the media buy catches up towards the end of the campaign, then the exchange will not charge for the over delivery. An Agency will have the control to specify the type of inventory that should be used to cover the under delivery as well as the amount of the under delivery. Other aspects of the inventive method relates to a computer-implemented system in an open exchange environment that will ensure delivery of advertising inventory so an agency can bill the client for the budget.

An automated exchange may act as an insurance program for delivery shortfall making sure that the campaign budget goals are achieved. If the other media buy recovers the shortfall before the flight end date, the exchange will not charge the agency for the excess media.

By providing interactive, adaptive, and automated filling of ad media in the delivery shortfall of other media buys on the plan with inventory from the exchange this invention has immediate application in advertising space of the World Wide Web (“web”, “Internet”, or “online”) at all levels.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIG. 1 depicts an illustrative embodiment of the high-level ownership and trading dynamics that are present in an embodiment of the present invention;

FIG. 2A depicts a first portion of an embodiment of a system that is in accordance with the invention;

FIG. 2B depicts another portion of an embodiment of a system that is in accordance with the invention;

FIG. 3 illustrates a process in accordance with the embodiment of FIGS. 2A and 2B;

FIG. 4 depicts an illustrative embodiment of a market accessor tool in accordance with the invention;

FIG. 5 depicts an illustrative report generated by an embodiment of the present invention;

FIGS. 6A-B illustrate two conventional approaches for delivering advertisements;

FIGS. 7A-B depict other portions of the embodiment depicted in FIG. 2A;

FIG. 8A-B depict other portions of the embodiment depicted in FIG. 2A and

FIG. 9 depicts another embodiment of a market accessor tool.

FIG. 10 illustrates a client-server computer network (e.g., the Internet) constructed in accordance with an embodiment of this invention.

FIG. 11 illustrates an example processing operation to serve and track advertisements in accordance with an embodiment of this invention.

FIG. 12 illustrates an example user interface process that an advertiser executes in accordance with an embodiment of this invention.

FIG. 13 illustrates an example processing operation that an advertiser executes in accordance with an embodiment of this invention.

FIG. 14 illustrates a processing operation for an advertiser from an exchange operator's point of view in accordance with an embodiment of this invention.

FIG. 15 illustrates an example user interface process that a publisher executes in accordance with an embodiment of this invention.

FIG. 16 illustrates an example processing operation that a publisher executes in accordance with an embodiment of this invention.

FIG. 17 illustrates a processing operation for a publisher from the exchange operator's point of view in accordance with an embodiment of this invention.

FIG. 18 illustrates a processing operation for billing and accounting in accordance with an embodiment of this invention.

FIG. 19 illustrates an example system architecture which may be used in accordance with an embodiment of this invention.

FIG. 20 illustrates processing operations undertaken by advertisers, publishers, and the exchange operator in accordance with an embodiment of this invention.

FIGS. 21A-21C illustrate several advertising negotiation and payment models in accordance with an embodiment of this invention.

FIG. 22 illustrates a processing operation for a many-to-many exchange in accordance with an embodiment of this invention.

FIG. 23 illustrates the effect of dynamic pricing on impression volume and reach of an advertisement in accordance with an embodiment of this invention.

FIG. 24 illustrates another system architecture in accordance with an embodiment of this invention.

FIG. 25 illustrates a exchange website architecture in accordance with an embodiment of this invention.

FIG. 26 illustrates another website architecture specific to advertisers in accordance with an embodiment of this invention.

FIG. 27 illustrates an example advertiser home page graphical user interface in accordance with an embodiment of this invention.

FIG. 28 illustrates an example offer management web page in accordance with an embodiment of this invention.

FIG. 29 illustrates an example offer editor web page in accordance with an embodiment of this invention.

FIG. 30 illustrates an example banner management web page in accordance with an embodiment of this invention.

FIG. 31 illustrates an example banner editor web page in accordance with an embodiment of this invention.

FIG. 32 illustrates an example URL management web page in accordance with an embodiment of this invention.

FIG. 33 illustrates an offer state transition diagram in accordance with an embodiment of this invention.

FIG. 34 illustrates a contract state transition diagram in accordance with an embodiment of this invention.

FIG. 35 illustrates a physical network diagram in accordance with an embodiment of this invention.

FIG. 36 illustrates another system architecture in accordance with an embodiment of this invention.

FIG. 37 illustrates a classification system architecture in accordance with an embodiment of this invention.

FIG. 38 illustrates a pricing process in accordance with an embodiment of this invention.

FIG. 39 provides a schematic diagram depicting how Advertisers bid to Publisher pages.

FIG. 40 provides a schematic diagram depicting how the Publisher requests Advertiser pages.

FIG. 41 provides a schematic diagram depicting an online Advertising marketplace as supported by the present invention.

FIG. 42 is a schematic view of an online exchange system for trading ad media according to the present invention.

FIG. 43 is a schematic drawing of the main modules of the online exchange system of FIG. 42.

FIG. 44 illustrates a flowchart showing the required steps for the automated monitoring of the under delivery and the steps required to fill the under delivery with inventory from the online exchange system of FIG. 42.

FIG. 45 is an example of a screenshot interface by which a buyer can specify the percentage of under delivery to be covered by the online exchange system of FIG. 42;

FIG. 46 is an example of a screenshot interface by which the online exchange system of FIG. 42 will not charge the buyer for any delivery above the campaign budget.

### DESCRIPTION

The Description is organized as follows.
I. Marketplace for Internet Ad Media and Delivering Ads
II. Online Exchange for Internet Ad Media
III. New Open Insertion Order System to Interface with an Exchange for Internet Ad Media

### I. Marketplace for Internet Ad Media and Delivering Ads

A system may manage a marketplace where parties may buy, sell, and manage Ad Media; as well as manage categorization and delivery of ad requests according to specifications provided by the respective owning parties (e.g., publisher or advertiser or agents thereof). While publishers and advertisers are users of the system, an end-user is the target of the advertising and is typically an individual accessing a web page and reading its content and advertisements.

Different embodiments interrelate the following elements:
1. A set of publishers, each representing a property (i.e., advertising space on a webpage), a network, an aggregation of properties, that contains pages where ads may be shown.
2. A set of advertisers, each owning one or more advertisements that the advertiser wishes to have displayed to end-users under certain defined conditions.
3. An Ad Media exchange marketplace (herein referred to as “exchange marketplace or “exchange” interchangeably and without differentiation), where parties may buy and/or sell media with each other according to free market prices, using standardized or customized tools.
4. An inventory of Ad Media, comprising a projected quantity of ad requests to be filled as users request and view publisher pages, where the pages contain space available for advertising
5. A set of media traders (e.g., media buyers and/or sellers), each able to transact media purchases and sales on the marketplace of the present invention
6. A media classification module, which is operable to perform real-time classification of the ad requests comprising the inventory of Ad Media. The module is implemented in hardware, software, or a combination thereof, and is operative in a computer-based Internet capable system.
7. A set of media “buckets,” each comprising a part of the complete Ad Media inventory managed by the system, where each bucket contains a quantifiable inventory of media. Each member of the Ad Media inventory has the same properties (e.g., such as page category, publisher site, time of day or month or year, and geographic location of the end-user), or a subset thereof being a constituent of the bucket.
8. A set of market accessor tools, each such tool enabling its user to perform a combination of: 1) transacting business (e.g., placing buy and sell orders) on the marketplace embodying the present invention; 2) viewing available media buckets, their properties, quantity available, and current market prices; and 3) viewing and managing media currently owned by that user or the party he represents. Additional information and tools may also be provided by these tools such as detailed status of executed trades that are currently partially fulfilled. By way of example, if the trader has executed and cleared a buy order for up to one million impressions in a particular media bucket to be delivered during the month of February 2007, on February 10th the market accessor tool can show partial delivery and prorated charges according to ad requests routed to his ad server by the exchange during the first 1 0 days of the month. The market accessor tool can be implemented as hardware, software or a combination of hardware and software.
9. A tag routing module able to receive, classify (via the classification module) and route ad requests in real time to the ad server(s) specified by media owners.

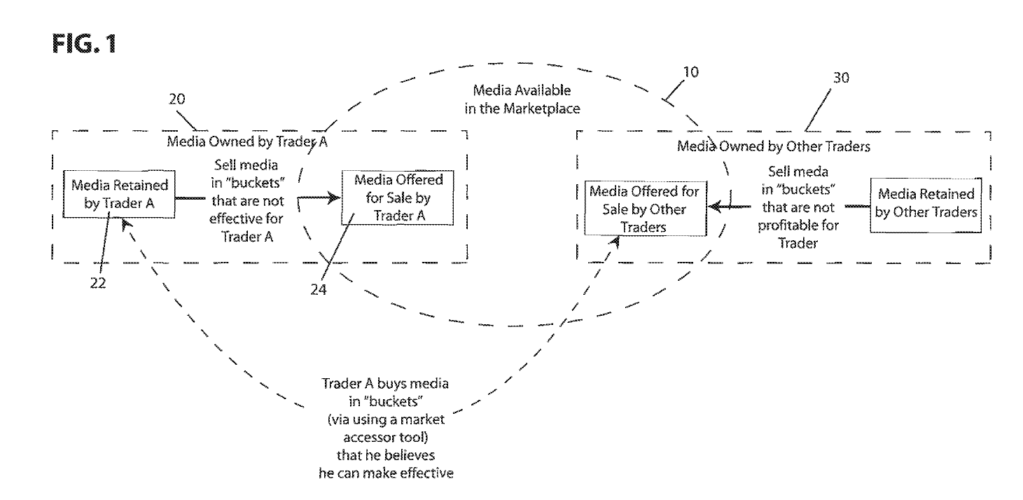

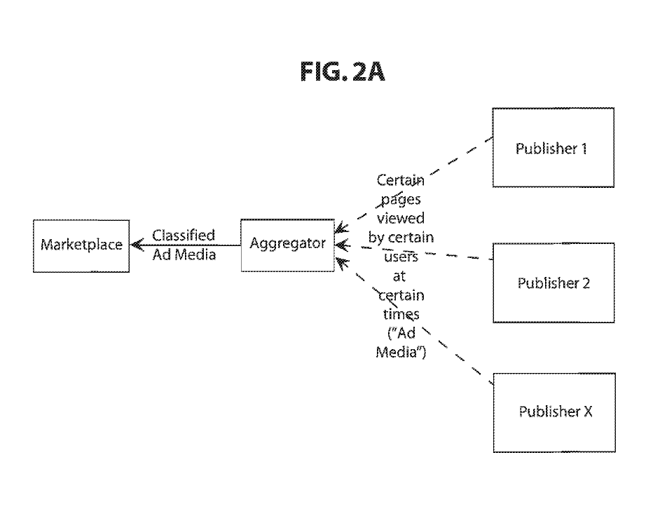

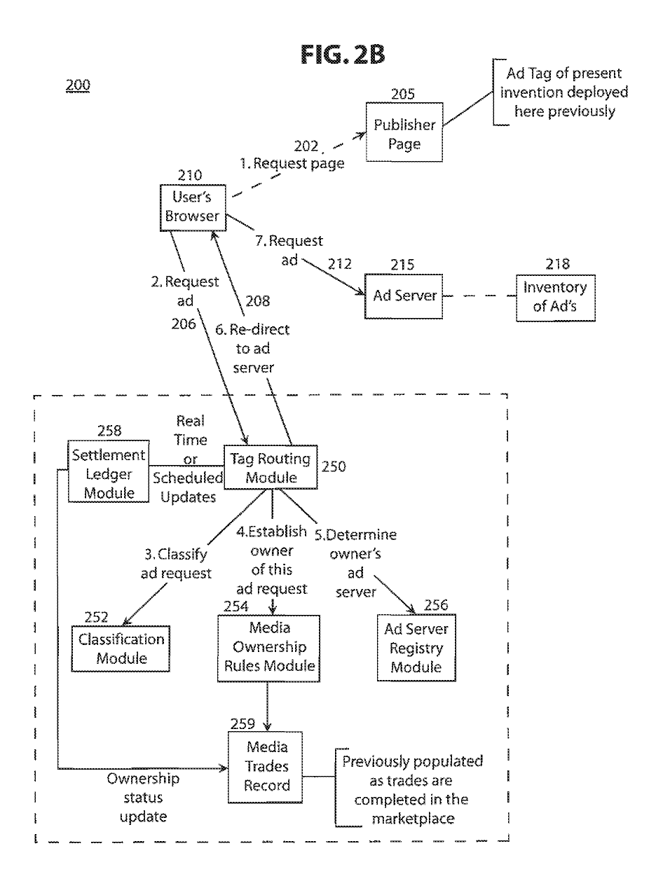

FIG. 1 illustrates the high-level ownership and trading dynamics relating to the open marketplace 10 where media buying and/or selling activities are carried out by parties interchangeably in order to optimize their owned-media for certain ad campaigns. FIG. 1 depicts an individual media trader (media buyer and seller), Trader A, who owns an inventory of classifiable media 20. The classifiable media can be processed by a classification module 252 as shown in FIG. 2B. The media owned by Trader A includes an effective portion 22 and an ineffective portion 24. Trader A retains the parts or “buckets” that are effective 22 and offers the ineffective parts or “buckets” 24 for sale to other traders 30 in the market place. A person of ordinary skill in the art will readily understand that the media buckets or classifications that are ineffective to Trader A might be more effective for the other traders 30 offering other products or running different ad campaigns. Furthermore, Trader A is able to grow an inventory of effective media 22 by observing the classifications of the effective media, and placing orders in the marketplace to purchase more media having that classification.

The orders placed by Trader A can be filled with media that in turn is offered for sale by other traders 30 for whom that media classification (or “bucket”) has proved ineffective. Thus, what might be ineffective for Trader A could be effective for other traders 30, and vice a versa. Free market pricing is an exemplary pricing model that allows market price to be determined based on supply and demand. Buyers may raise price offers or bids when not enough supply is offered, and sellers may lower price offers when there is not enough demand.

FIG. 2A depicts one portion of an embodiment of the present invention where an aggregator consolidates Ad Media from many sources, Publisher 1, Publisher 2, Publisher X. By classifying like Ad Media the aggregator creates buckets of commoditized Ad Media that can be bought and sold as an individual tradeable unit, or a quantity of units, on the marketplace. Once classified and commoditized these tradeable units can have different market values depending on their classification, and can obtain higher market value in comparison with unclassified or more broadly classified units. These commoditized media units are fungible within their category, and are tradeable as such in the exchange marketplace embodying the invention. The aggregator, or entities operating the exchange marketplace, can generate revenue for themselves by charging transaction fees to traders on executed trades, either on a flat rate or a percentage of funds transacted basis.

Fees may also be charged to media owners according to the volume of ad media or traffic directed for delivery to that owner via the tag routing module 250 of FIG. 2B. This volume can be quantified, for instance, as a fixed-rate fee per thousand impressions delivered, or per user click, or response to an exchange-delivered ad unit, or per purchase or conversion, and it will be understood by those familiar with the art that there are other standard ways for the exchange operator to generate revenue for itself through fees proportional to the volume delivered.

The exchange operator can also charge fees by charging traders for each seat or account permitted to trade on the exchange platform. Exchange operators may create asset accounts for each trader, where each account can carry a combination of cash, credit, and assets in the form of sellable Ad Media. Fees such as described above may be charged via debits applied to these accounts.

The commoditized media units can be a conglomeration of Ad Media from one or multiple publishers, different web pages located at the same or different websites, related by context, related by end-user criteria such as demographics or internet connection attributes (e.g., browser type and configuration˜internet connection speed) or geographic location, or the number of times the page has been seen by that user in a recent time period (related by day, date, or time of day, and/or any combination thereof). As is readily apparent to persons of ordinary skill, other rules for classifying the various components of the commoditized media unit can be devised and would be within the spirit and scope of the present invention. As an example, the commoditized media unit can be a category of Ad Media from multiple web pages that provide reviews of computers, computer peripherals, and computer software. These commoditized units can at the same time be restricted to media requests from west coast end-users who might visit the sites within the allocated ad space on a particular day, or time. The commoditized unit would be associated with a quantity of Ad Media bought and/or sold in the marketplace. In the exchange marketplace of the present invention there are available multiple units of the same commoditized unit.

In one embodiment, the contents of each commoditized unit category are unknown to the purchaser of the unit category, as the commoditized units are traded on the exchange marketplace “site blind.” Being “site blind” keeps the identity of the web page publisher hidden. This is done so that publishers who sell their Ad Media through conventional channels at higher prices can still offer remnants of their Ad Media on the exchange marketplace without impacting the pricing of the conventional market.

However, tools are provided by the exchange marketplace so that advertisers can evaluate the effectiveness of a particular commoditized unit category. This gives advertisers visibility into their ad campaign by sub-category, and thus, ineffective commoditized unit categories are identifiable by the advertiser, and can be offered back on the exchange marketplace for sale to another.

FIG. 2B depicts another portion of system 200 which supports the exchange marketplace between media buyers and/or sellers. System 200 provides a standardized marketplace where parties can meet to buy and/or sell media according to free-market prices and a standard categorization approach. A party who buys media in one transaction can later sell a portion of that same media-buy to another party. Thus, one party can be both a buyer and a seller. Each party who buys and/or sells media in this marketplace is provided a standard tool for viewing and managing currently owned media, their pending buy and/or sell orders, the media which is currently offered for sale, and the requests for media purchase in the marketplace. They may also view details of their past executed trades that are currently partially fulfilled by viewing intra-month delivery statistics and proportional charges. The tools are standardized for all parties and the marketplace platform uses a consistent automated media categorization scheme. Due to this consistent categorization scheme, user-customized tools are also within the contemplation of this invention. This approach streamlines marketplace transactions and provides clear visibility of the effectiveness of each media owned by a party utilizing granular metrics to the level the market demands.

Beyond being a marketplace for buying and/or selling media and managing owned media, the system 200 also includes a delivery aspect. The system can broker ad requests generated for media transacted on the marketplace platform by performing real-time categorization of each request. By brokering the request, the system identifies the media buyer who owns the ad request and associates the appropriate Ad Tag (i.e., the Ad Tag registered in the system to that media buyer). This association by the system results in the ad request being routed to the media buyer's desired Ad Server. Thus, the system can cause the actual delivery of the advertisement.

In the case of trades that are defined as Settled-On-Delivery, this real time routing process also interfaces with a settlement ledger module 258 of FIG. 2B that records both real time, or near real time, ad-request delivery statistics, and corresponding aggregate charges for debiting to the account of the trader account who received each ad request.

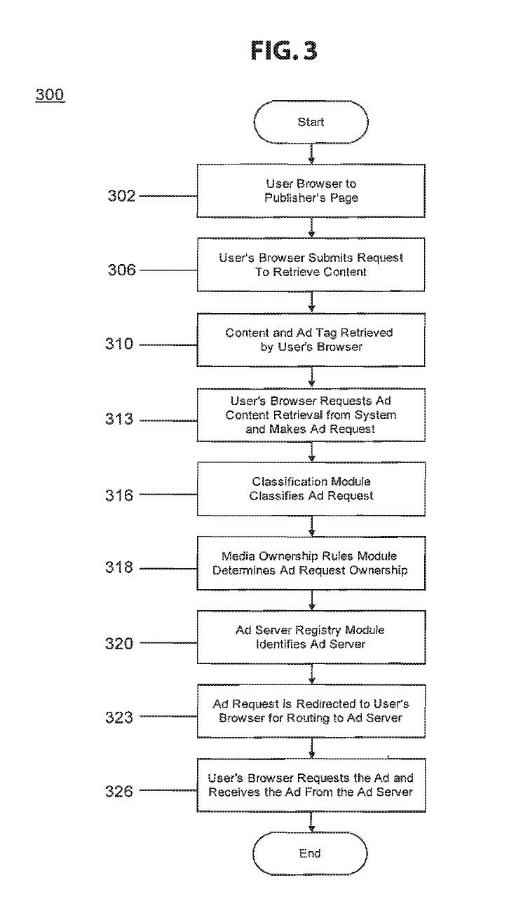

FIG. 2B illustrates a system 200 embodying the present invention configured to deliver ads to fill the media that has been sold in the marketplace. FIG. 3 illustrates a process 300 in accordance with the embodiment of FIGS. 2A and 2B. A description of system 200 and process 300 follows. At step 302, an end-user browses the Internet using a web browser 210 and arrives at a page 205 owned by a publisher who has sold media on the marketplace. The publisher page 205 includes an Ad Tag placed by the publisher and related to the media buyer as discussed above. The user's web browser 210 submits a request 202, step 306, to the publisher's page 205 to retrieve the content of that page. At step 310, the publisher's page content and the Ad Tag are sent to the user's browser 210.

The user's browser executes the Ad Tag retrieved with the content of the publisher page, causing an ad request 206 to be made, step 313, to the system 200 to retrieve ad content. The classification module 252 classifies, step 316, the ad request 206 into one of the buckets defined in the marketplace. At step 318, the media ownership rules 254 are consulted to determine ownership of ad request 206. In one embodiment the media ownership rules are updated after trades are executed in the marketplace. These updates can be made continuously as the trades are executed. As soon as is practicable, the fulfillment of a trade's quantity can be reflected in the system's routing decisions. Similarly, if a trade's quantity is close to being fulfilled, or not close to being fulfilled, the system can route a higher or lower percentage of ad requests in that category to that party accordingly.

Process 300 continues at step 320, where the ad server registry module 256 identifies, based on the owner of the ad request 206, which registered ad server 215 has the responsibility to deliver the ad content 218 to the user. The ad server 215 is registered by the media owner with the system 200 and entered into the registry module 256 prior to completing the purchase of that media in the marketplace.

The tag routing module 250 routes, step 323, the ad request 206 to the ad server 215 identified by the ad server registry module 256. This routing can be accomplished by sending a redirect instruction 208 back to the user's browser 210. The user's web browser 210 then requests and receives, step 326, an ad from the ad server 215. The ad server pulls the ad from its own ad inventory 218.

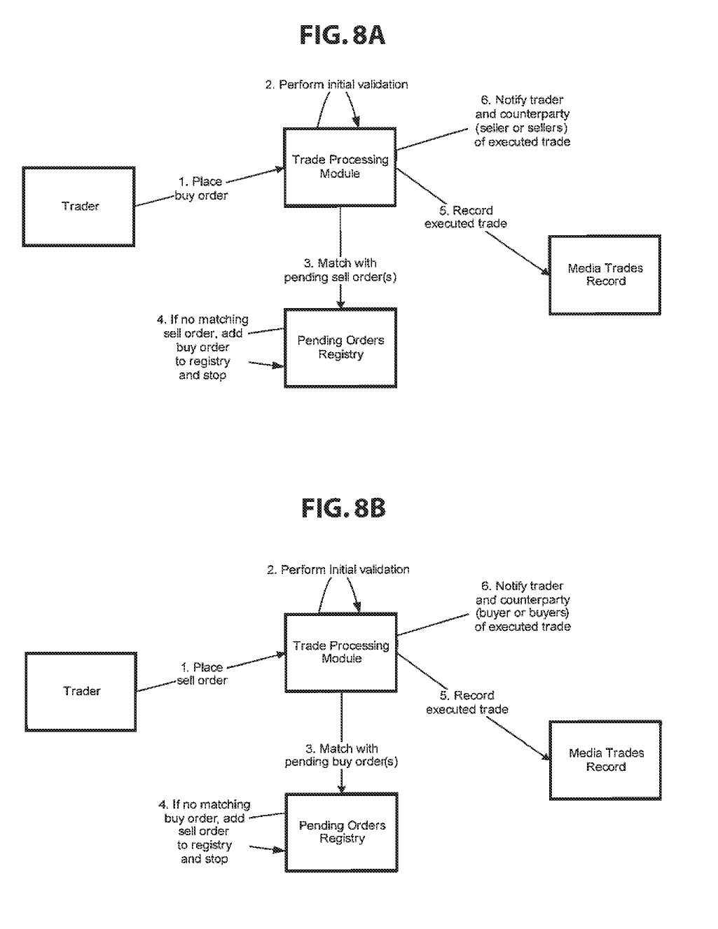

Also shown in FIG. 2B is a Media Trades Record Module 259. The Media Trades Record Module integrates trades executed on the exchange marketplace with the ad request routing described above. With reference to FIGS. 8A and B, the Media Trades Record Module receives and makes a record of each trade (whether buy or sell) on the exchange marketplace. System 200 also interfaces with the Media Trades Record Module. To route an ad request, the Tag Routing Module 250 accesses the Media Ownership Rules Module 254 to determine which media buyer owns the Ad Request and has the right to deliver advertisements in response to that request. The Media Ownership Rules Module 254 queries the Media Trades Record to determine the media owner, and just how much ad-request inventory of this type the owner still has a right to receive. In one embodiment, the amount of Ad Media ascribed to a particular media buyer is decremented as ad requests are routed to its server through the efforts of the Tag Routing Module 250.

Once the identity of the media owner is determined, the Ad Server Registry Module 256 acts to associates the ad request with the correct ad server for that media owner. The Registry Module 256 contains the technical details on how the ad request redirection instruction should be constructed for routing to the media owner's ad server. When these ad requests are routed over the Internet they typically use the HTTP protocol, such that the redirects are sent as 300 or 302 response codes from the tag router module to the user's browser. On that redirection response the tag router includes the full URL including any query string parameters or HTTP post data according to the technical data registered in the Ad Server Registry Module. That registry module can therefore include each ad server's address as well as URL construction information such as generalized query string and post data parameters. It is also within the spirit of this invention that the ad requests or redirections may be made using richer protocols such as SOAP, REST, or other web services protocols built on top of HTTP. The particular details are not limiting to the invention, so long as the ad request is properly formatted to continue to the correct ad server when it is forwarded back to the user's browser 210, as described above.

FIG. 2B also depicts a Ledger Module 258 in communication with the Tag Routing Module. As ad request redirections are sent to the user's browser, the Tag Routing Module 250 can send notice to the Ledger Module 258. These notices can come from the Tag Routing Module 250 in real time as the ad request is forwarded, or can come at scheduled intervals. The Ledger Module 258 tracks the notices for each ad media buyer for billing purposes. In one embodiment, for instance, billing can be done incrementally as an ad request is forwarded out of the Tag Routing Module. Billing can also be done once a preset threshold is reached, or on a time dependent criteria (e.g., hourly, hi-hourly, daily, etc.). The Ledger Module can also track these notices and develop information on the publisher receiving the advertisement, so that revenue for the exchange marketplace operator can be generated by billing both the Ad Media buyer and seller.

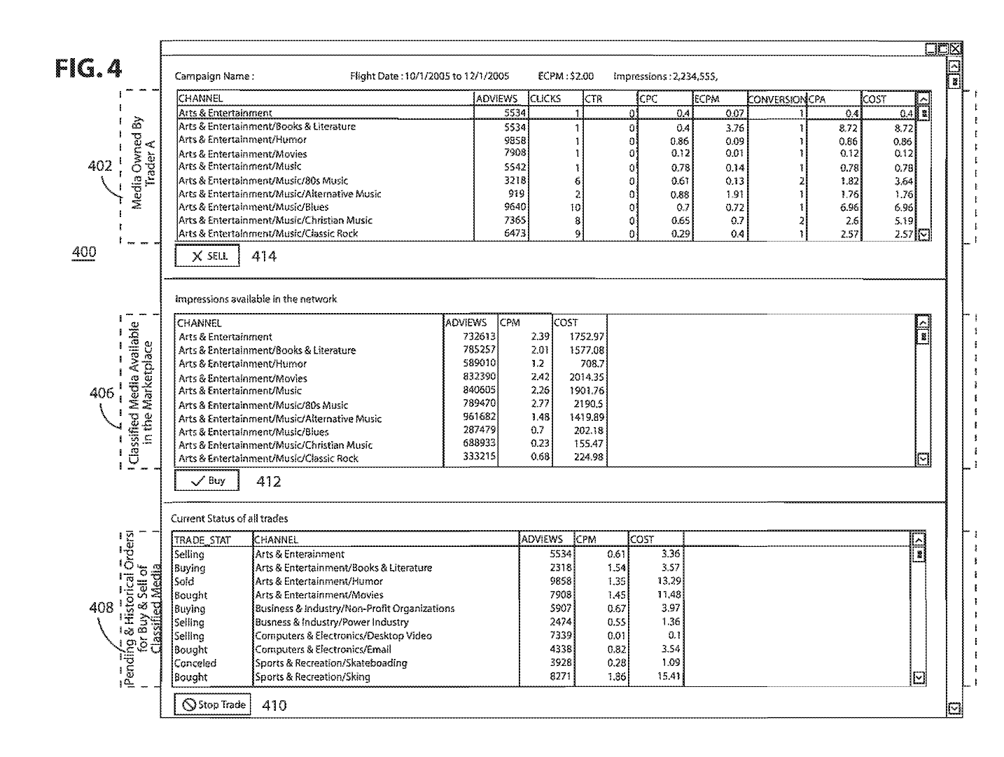

An embodiment of the invention enables media traders to transact business in the marketplace by use of marketplace accessor tools. FIG. 4 depicts an interactive display 400 of an embodiment of the market accessor tool.

The software application that presents the interactive display 400 enables media traders to view all currently owned media 402. The media can be grouped by bucket or classification 404 (labeled “channel” in FIG. 4), and optionally filtered by one of a multitude of ad campaigns currently managed by the media trader. The attributes that define each bucket or classification are visible, as are performance statistics for the ads that have run in a particular period of time. Examples of these attributes include, but are not limited to, the contextual category of a currently viewed page, a part thereof, or other pages related by links, etc.; the domain name of the currently viewed page's address; an account number or identifier assigned to the publisher when they subscribed to the system; the geographic location (e.g., country, state, zip code, etc.) of the user requesting the page; demographic information (e.g., age, gender, interests, background, etc.) of the user requesting the page; information about when the page was requested by the user (e.g., time-of-day, day-of-week, day-of-month, season of year, etc.).

The media trader may review these groupings and statistics to determine the effective media and the ineffective media for this campaign. For instance, information is presented regarding the CTR (click-thru-rate), which is a measure of how many viewers of the advertisement click on the embedded link to visit the advertiser's webpage. Also provided is information on the Conversion (how many viewers bought product from the advertiser), and the Cost (a measure of how much the advertiser paid for these results). The media trader may offer to sell a quantity of media in the marketplace by highlighting a row and clicking the “sell” button 414. At that time a prompt appears to specify additional details about the sell order (not shown in the figure) such as the exact quantity to sell, and if the offer is more than market price then also the offered price and length of time to keep that offer open on the market.

Additionally, the interactive display 400 allows media traders to view all media currently offered for sale 406 by other parties in the marketplace. The same standardized classification semantics are used here as are used for the inventory owned by the media trader. Each bucket shows quantity available and asking price. The media trader is able to review this data to dynamically identify whether the marketplace contains media desirable for purchase. The data also permits consideration of whether to sell certain media by reviewing market prices versus the current effectiveness of that media for the media trader. If the media trader wishes to buy media, a buy order can be submitted to the exchange by highlighting the group and clicking the “buy” button 412. At that point the media trader can be prompted to specify additional details about the buy order (not shown in the figure) such as the exact quantity to buy, and if the offer is less than market price then also the offered price and length of time to keep that offer open on the market.

Further the interactive display 400 enables users to review currently pending and recent historical trade orders 408, with the ability to take certain actions on those orders such as canceling a pending order by clicking the “stop trade” button 410.

Other embodiments and implementations of the market accesor tool, consistent with the purpose of empowering users (e.g., traders and other actors in the marketplace) to transact business in the marketplace and to carry out other management and analysis activities related to the marketplace, are within the scope and spirit of the invention.

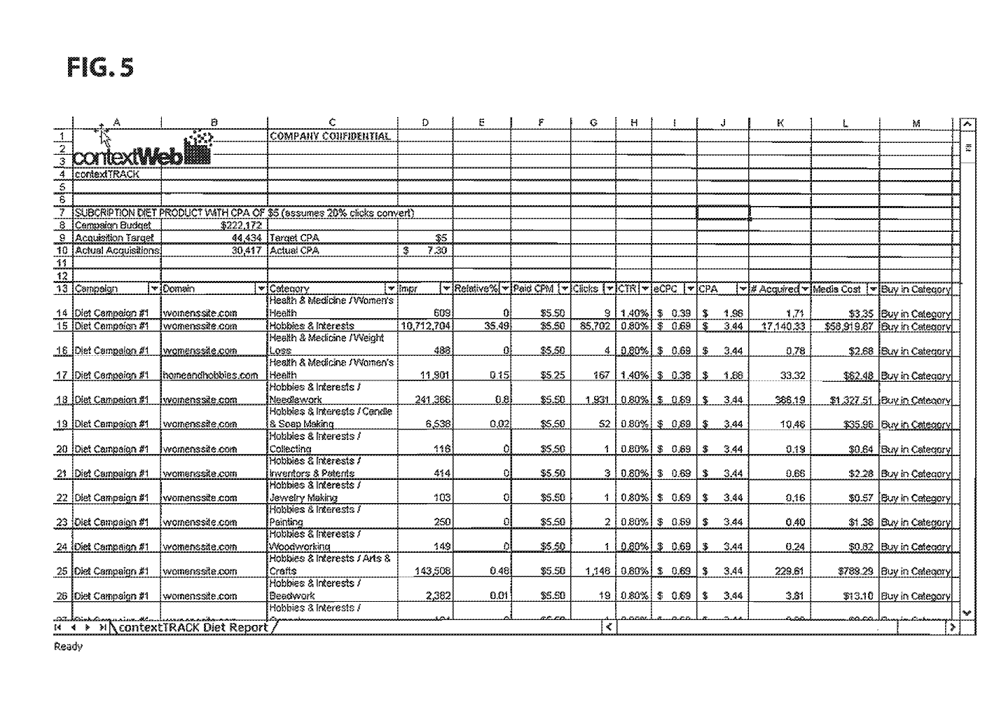

FIG. 5 shows an illustrative report generated by an embodiment of the present invention. Each ad campaign is listed along with the category of commoditized unit in which it being placed. Metrics are also provided to show the effectiveness of the ad campaign correlated to each of these commoditized units. Each trader (media buyer/seller) is granted access to use a market accessor software tool. The tool, an interactive GUI, enables the trader to view market inventory and prices, to place buy and sell orders in the marketplace, to view records of their completed trades, to view pending orders in the marketplace, to view their own currently owned inventory, to view historical performance of their media by category (classification), to use analytical tools related to the marketplace and to view their owned media. Other features aiding in the determination of the effectiveness of an ad campaign are also contemplated by the present invention to be a function/feature provided by the market accessor tool(s). The report shown in FIG. 5 is an exemplar of a performance report generated by a market accessor tool, and then viewed in a spreadsheet tool like Microsoft Excel.

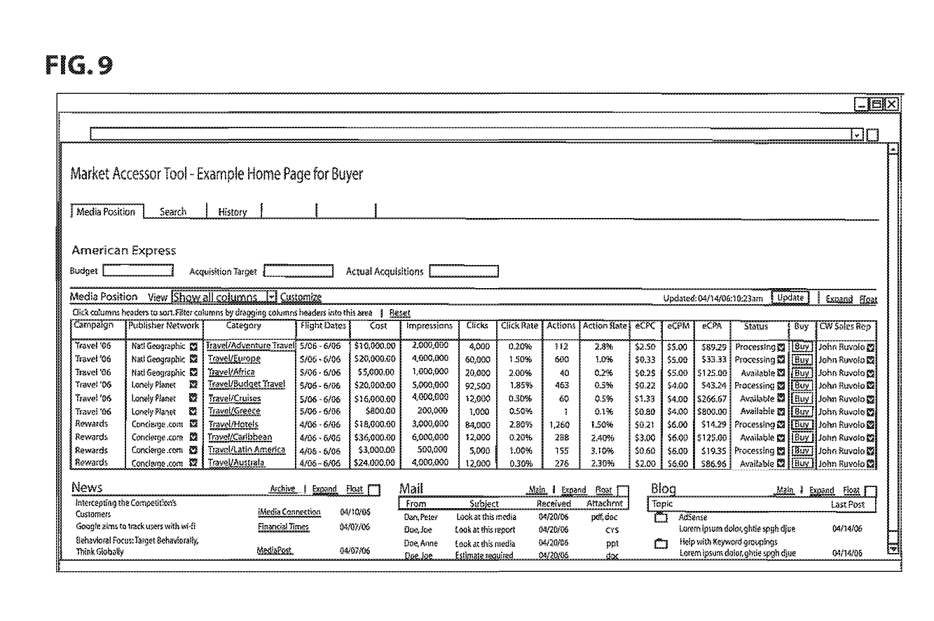

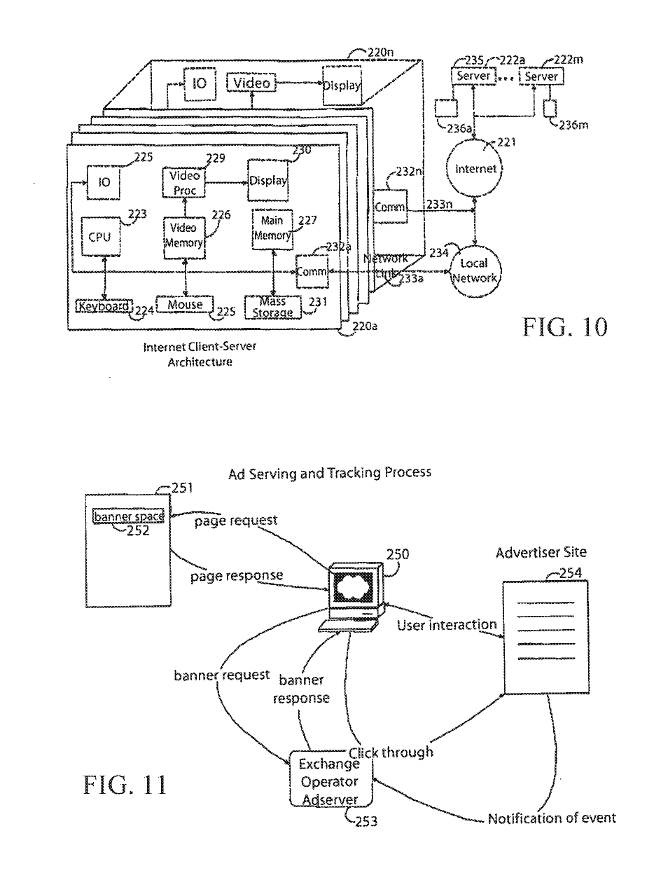

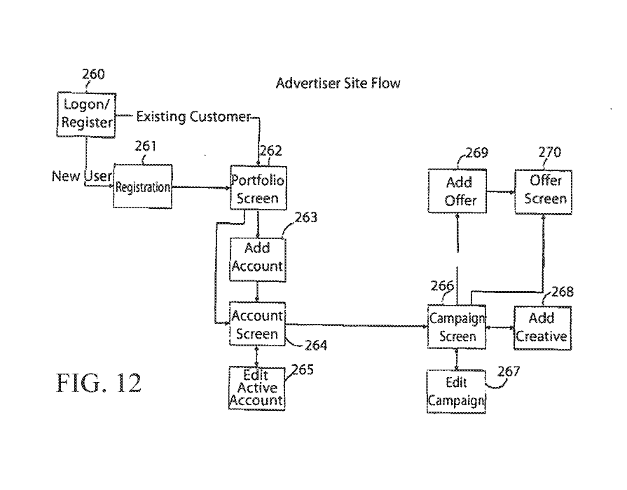

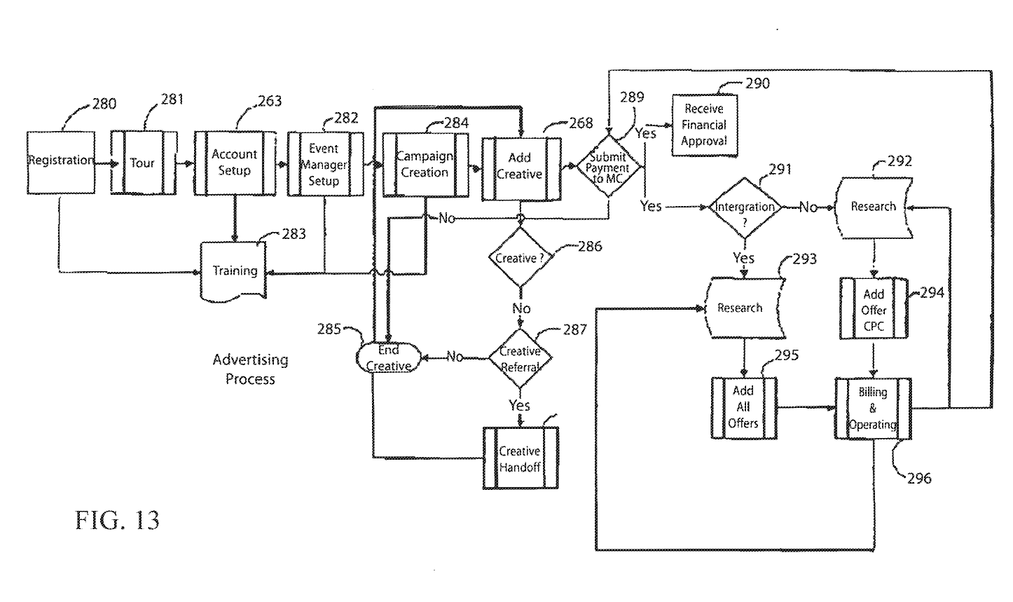

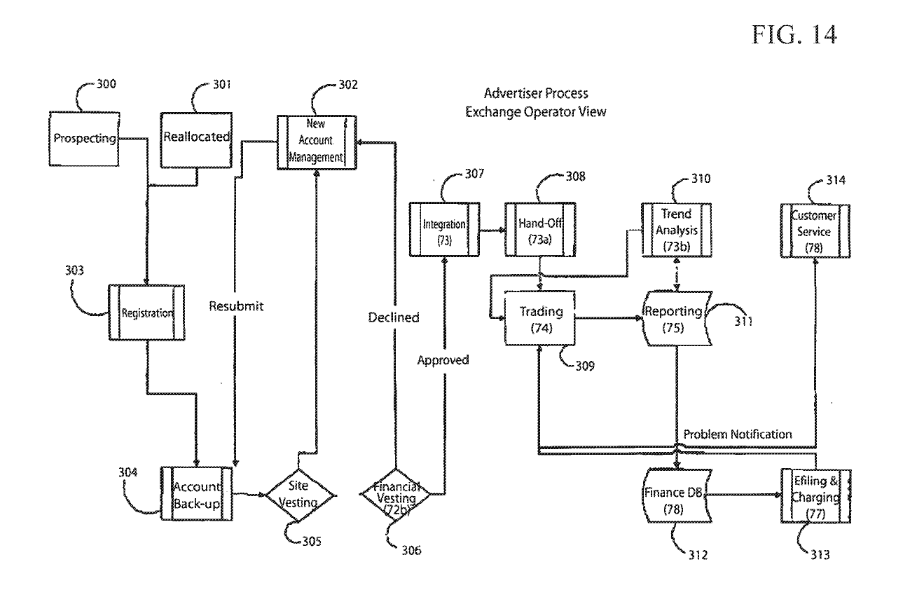

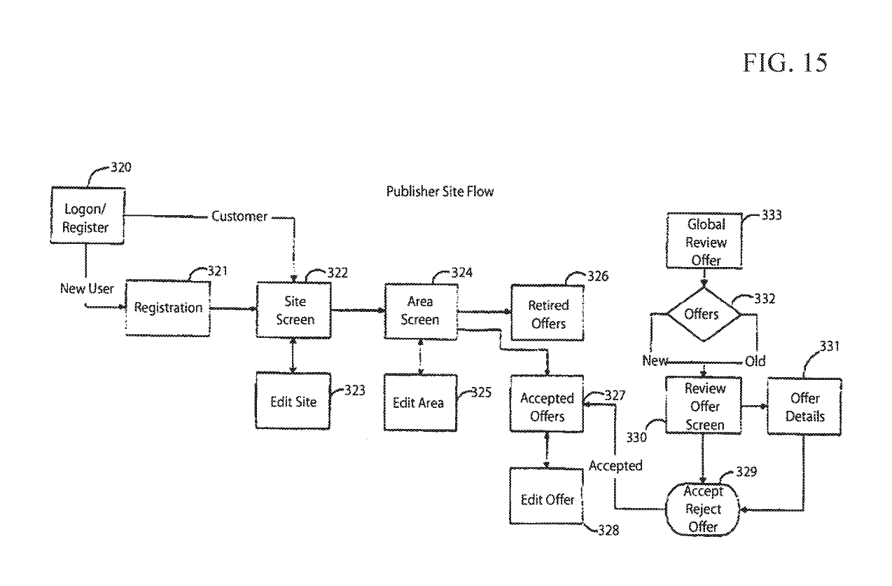

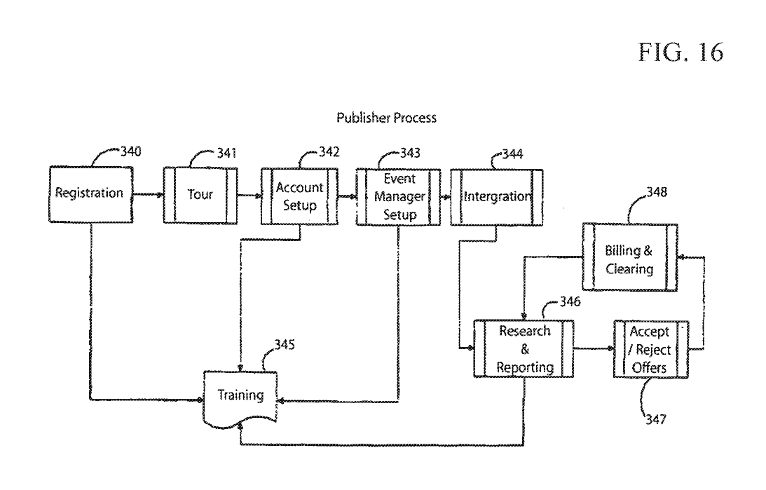

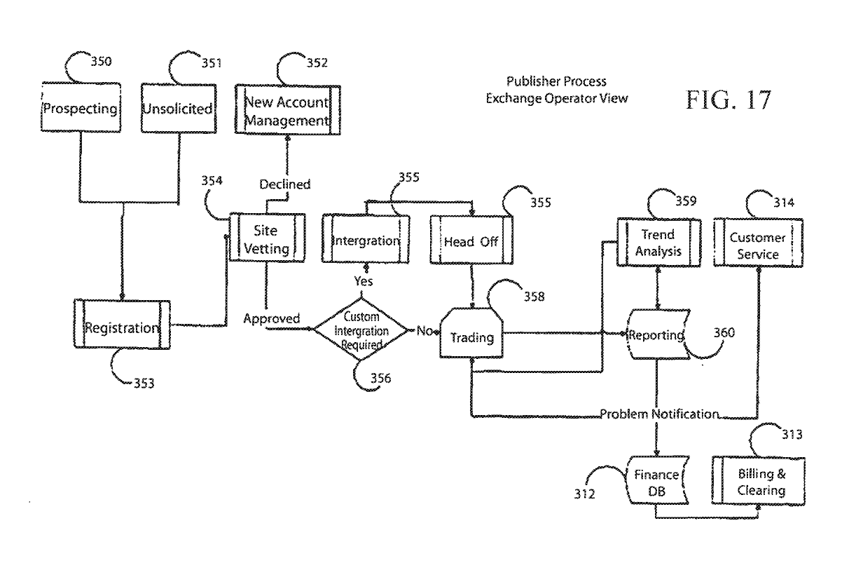

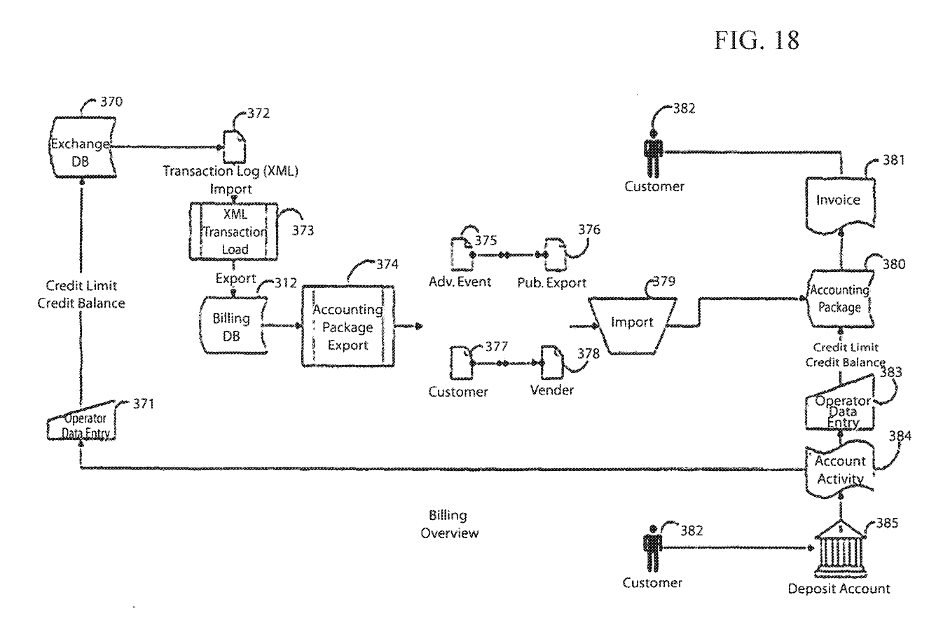

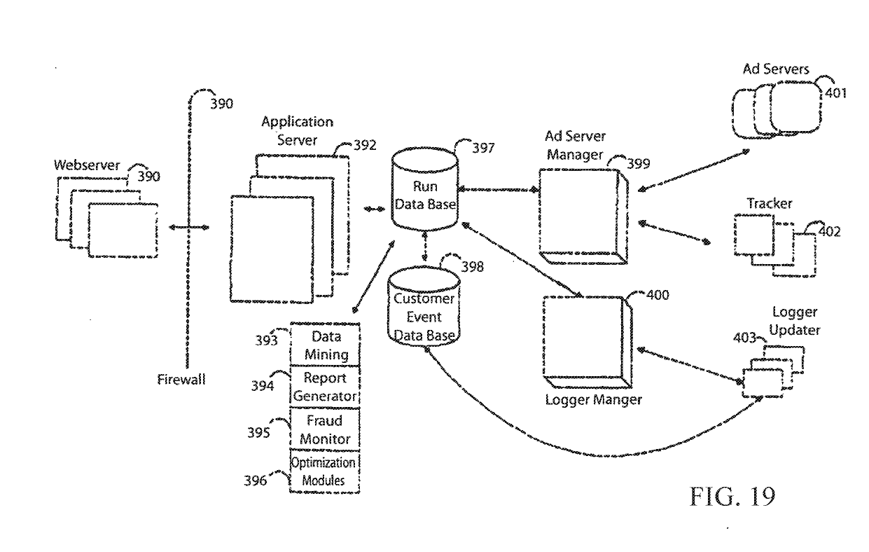

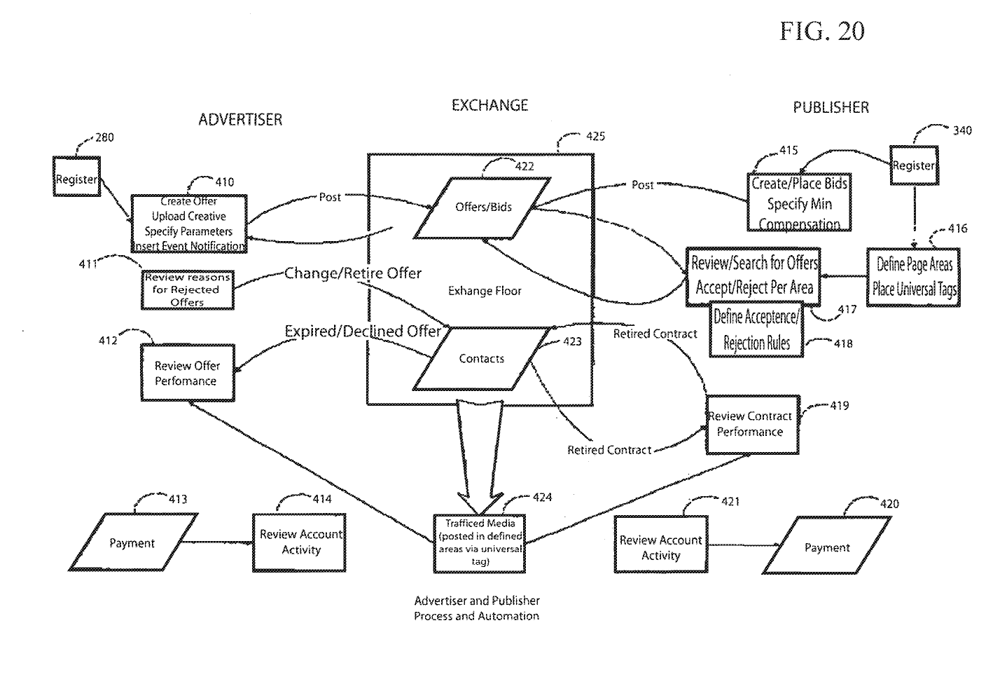

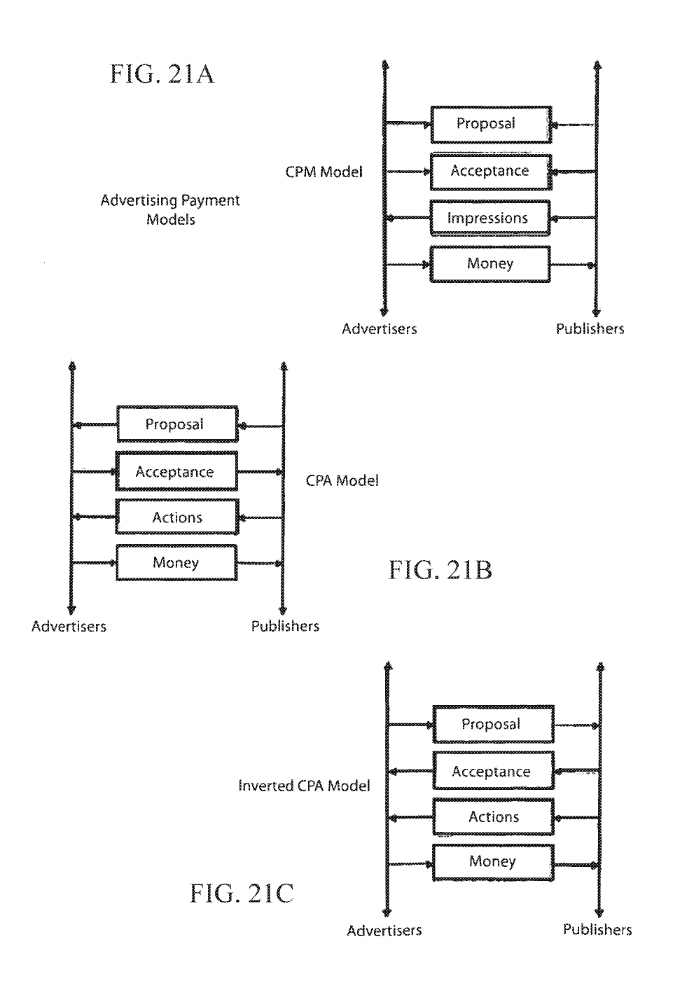

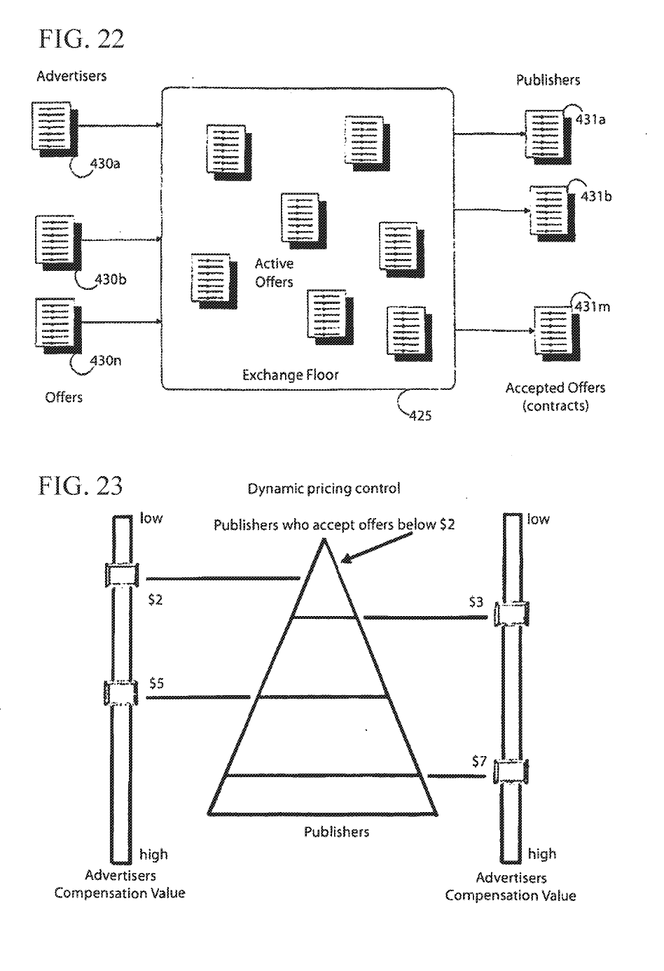

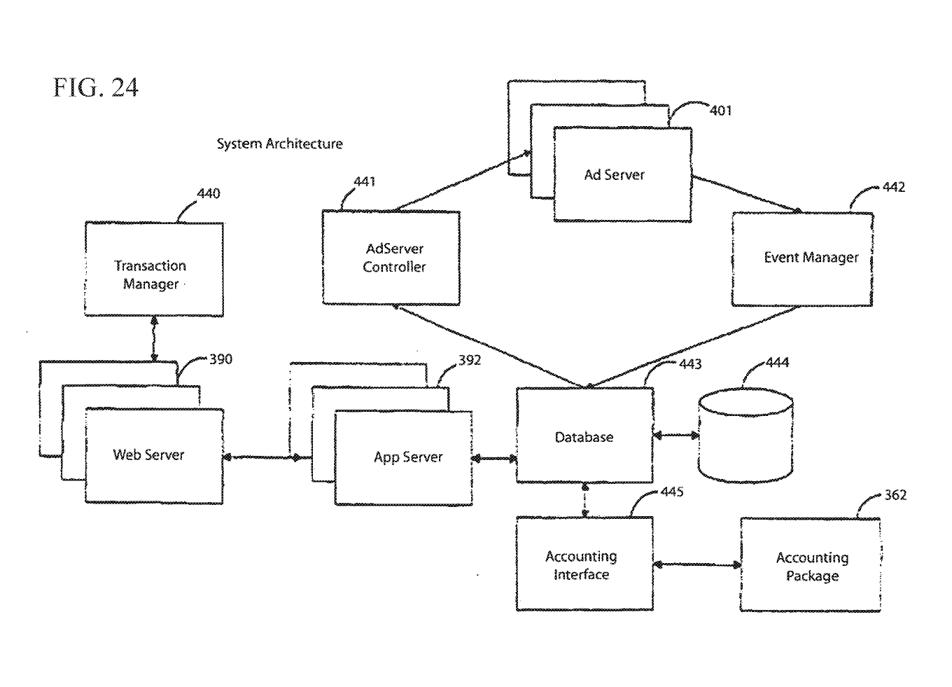

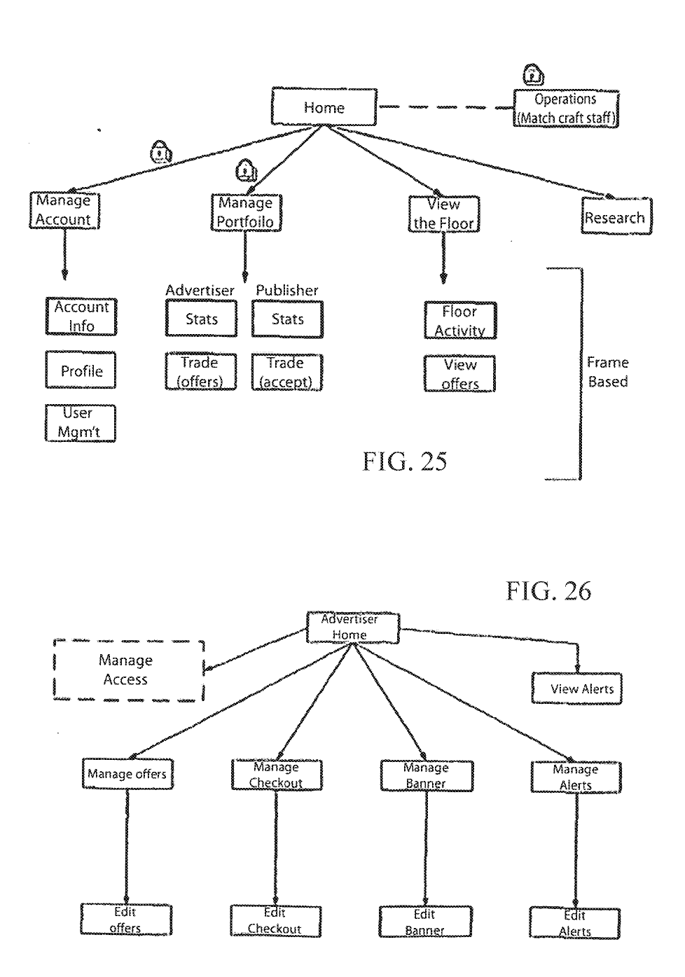

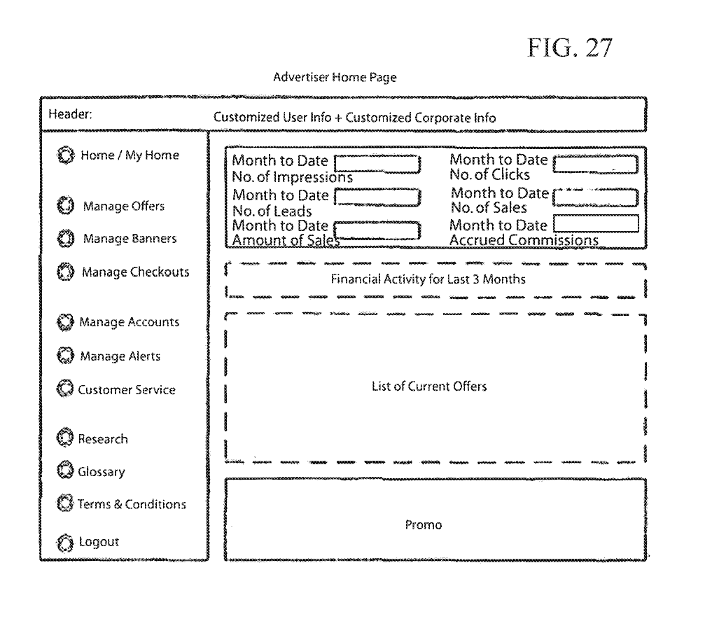

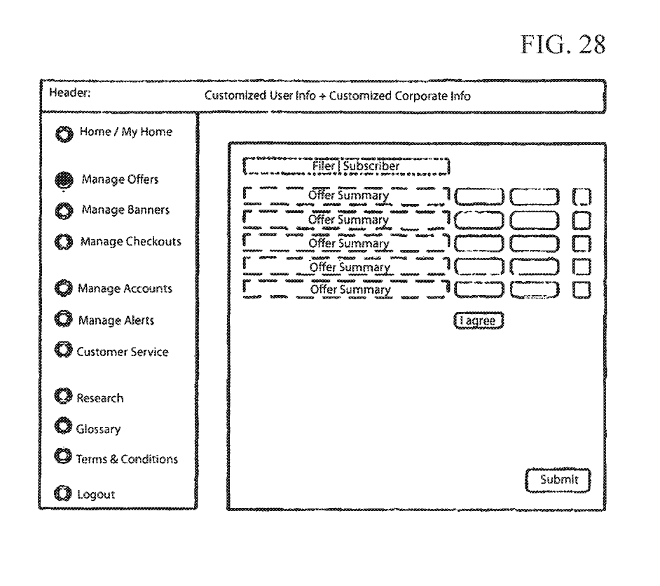

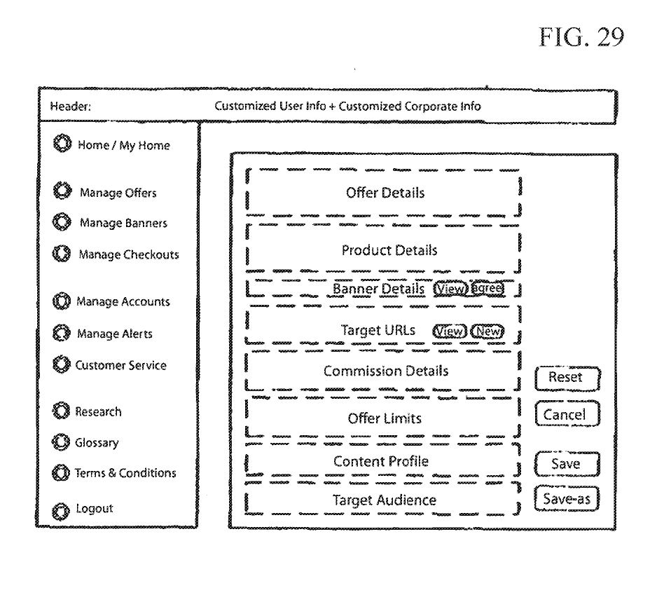

FIG. 9 depicts another embodiment of a market accessor tool. This embodiment is accessed by the trader visiting an appropriate Web address and logging into his account. Illustrated is a buyer-side detail view, but a seller-side view is equally available. In this view, the trader is a representative of American Express, as shown in the subtitle. The “Media Position” panel displays a list of ad campaigns that are running or scheduled to run. Displayed for each campaign are performance statistics such as number of impressions and clicks delivered by the exchange's Tag Router module in accordance with past media purchases made by this buyer on the exchange. The market accessor tool calculates the click rate from the number of impressions and clicks, and from the number of actions (conversions) the accessor tool calculates the action rate. By basing calculations on the financial cost of the campaign so far, the accessor tool also calculates the effective cost per click (eCPC), the effective cost-per-thousand impressions (eCPM), and the effective cost-per-action (eCPA). A status indicator signals the status of the particular campaign as being either Processing (delivery of ad requests into that campaign is still ongoing and has not yet been completely fulfilled according to the volume purchased), or Available (delivery is complete according to specifications). Ad campaigns indicated as Available can be restarted by clicking the Buy button, and then submitting a new buy order to the exchange marketplace to purchase additional media for that campaign. The accessor tool provides prompts to the user to enter the required information for the buy order (not shown). The “Media Position” panel also displays the name of the sales representative who was engaged to start that campaign. However, the participation of a sales representative is not required for the operation of the exchange or the accessor tools, but is presented in this discussion as an example of an additional type of user and data that can play a role in the marketplace.

FIG. 9 also depicts other related content and services that can be included in the accessor tools to make them more fully featured as a business platform for users. For example, the “News” panel displays recent industry news, which can be received into the exchange system by an electronic news feed, for example by RSS. The “Mail” panel displays an excerpt of the user's email box. The mailbox can be populated with messages from the exchange administrator, or from other traders communicating across a message layer supported by the exchange marketplace. The “Blog” panel is an integrated “web log” or discussion board, posted to and read by exchange members.

The sell side of this embodiment (not shown) includes tools that are aimed at providing counterpart information of interest to traders on the Sell side. The sell-side view can incorporate features substantially similar to those depicted in FIGS. 4 and 9, including a “Sell” button for active campaigns so that the user can choose the category within the campaign that they'd like to sell.

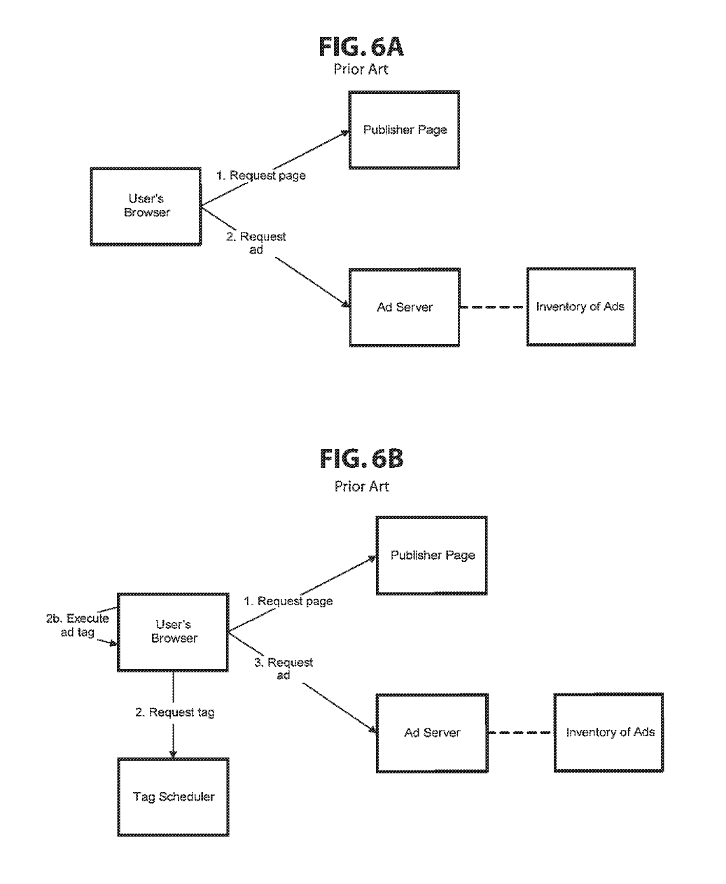

FIGS. 6A and 6B illustrate conventional approaches to delivering advertisements over the Internet to a user's browser. In the simpler approach shown in FIG. 6A, the user's browser requests a publisher's page from a first server, and an advertisement from an ad server connected to an inventory of ads.

FIG. 6B delivers ads using a tag scheduler. “Scheduling” is a term known to ordinary persons of skill in the art, and describes a process that lacks dynamic analysis when an ad tag is chosen for service. In the prior art, multiple ads or ad tags are merely scheduled for delivery from the ad server according to predetermined rules based on certain parameters such as a minimum and maximum number of deliveries per day, or per hour.

As discussed above, the classification module 252 shown in FIG. 2B classifies advertising traffic in real time. The term “ad traffic” throughout the written description means the real time sequence or stream of ad requests generated by users visiting web pages that contain the Ad Tags described in connection with the present invention.

The previously discussed Ad Media can be considered the estimate of future expected Ad Traffic, each of which can be classified by the several embodiments of the present invention. There are many attributes of this ad traffic that can be considered as part of this classification process, as also mentioned earlier. Of these many attributes one attribute that is particularly valuable and lacking in the prior art prior to the invention described in U.S. Published Patent Application No. 2002-0123912-A1 is the contextual category of the traffic, determined by examining the content of the page where the ad is about to be shown. It would also be consistent with this real time contextualization process to consider certain subsections of that page content more than other subsections, and also to consider other pages related to the page requested by the user, those related pages being related for example by hyper links present on either page.

This contextual content analysis can be accomplished by the Classification Module 252 submitting real-time requests to publisher sites to retrieve the content requested by the user for viewing in his browser. The Classification Module upon receiving that content analyzes it to determine its category or categories (a.k.a. topic or channel). These categories can be hierarchical so that a page classified as “Entertainment 4 Sports 4 Baseball 4 New York Yankees” may be matched by the Media Ownership Rules Module 254 at any of those category levels depending on available inventory, typically giving preference to those that match at the deeper levels of specificity. Because the quality of ad performance (click-through rate, etc.) is often attributable to the topic of the page, including this contextual category information as part of the classification process makes the present invention a much more highly scalable and effective ad media marketplace and delivery system than exists in prior art. Media ownership rules present in Rules Module 254 are tied to the marketplace and are evaluated by reference to the record of trades completed in that marketplace. The prior art lacks any rules based on any relationship with a marketplace of commoditized Ad Media.

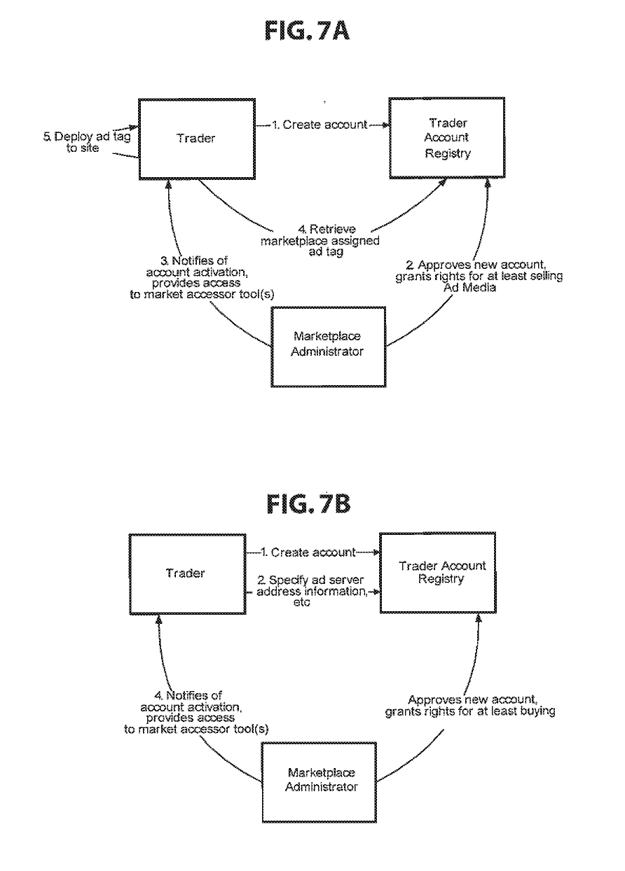

FIG. 7 A depicts the sequence that occurs when a trader, for example a publisher, desires to participate in the marketplace exchange embodying the present invention. The trader creates an account by registering, step 701, with a Trader Account Registry which accepts identifying information on the trader. A Marketplace Administrator reviews the new account information and issues, at step 702, an approval to the Trader Account Registry granting the new account at least rights to sell Ad Media in the commoditized marketplace exchange. Naturally, in certain instances the trader may also apply and be granted approval to buy media as well. The Marketplace Administrator, step 703, also notifies the trader of the account activation. At step 704, the trader retrieves a marketplace-assigned ad tag from the Registry. The trader can then deploy the assigned ad tag to its pages, step 705.

Each trader account can carry a certain level of security clearance. These security levels may be requested by the trader and approved by the exchange administrator. A trader account with a low security clearance might be able to see only that trader's owned media but not that offered for sale by others on the exchange. Another level might be able to see all available media on the exchange, but not be permitted to submit trades. Other implementations might have levels able to see reports on their own campaigns' progress toward completion, say by number of impressions versus total expected impressions, but might not have access to other campaign performance metrics such as CTR and eCPM. This flexibility allows a single organization to create multiple accounts, or seats, on the exchange with each having its own level of access to information and actions.

In other embodiments, a Marketplace Administrator need not be involved, and the Registry informs the Publisher of a successful registration. A proxy or agent can also be inserted into the sequence to represent, or stand in place of, either the Publisher or the Marketplace Administrator.

FIG. 7B depicts a further embodiment where the trader, at step 706, provides details to the Trader Account Registry. These details can be used in business rules to be applied by the Media Ownership Rules Module 254 of FIG. 2B. These business rules can include, but are not limited to, block lists (which allow parties to block competitive ads or sites), financial information (such as account deposit requirements, pre-paid, deposit, or credit).

FIGS. 8A and 8B illustrate two alternative embodiments on handling, placing, tracking, and executing orders for Ad Media on the commoditized marketplace exchange. In essence, as with any market exchange of commodities, buy and sell orders are matched and recorded. The parties to an executed transaction are notified automatically, and the trades are “settled” in the sense that ads are placed on the Ad Media within the commoditized units. This matching process does not require that a single buy order be matched to a single sell order or vice versa.

For example, a sell order for one million impressions in the category “Travel→Europe” to run in March 2007 can be matched to ten individual buy orders in the same category and time period for 100,000 impressions each. Any combination can be matched and cleared by the exchange, provided the categories and prices match and the quantities add up to the same on both sides. It is within the scope of this invention that all aspects of modern exchanges can be applied and practiced in this marketplace for commoditized units of Ad Media. These include, but are not limited to, speculative orders, leveraged purchases, puts, calls, limit and market orders, etc. There also can be “market makers” in some or all commoditized ad unit categories. A market maker is a party who is under an obligation to fulfill buy and sell orders placed by traders at the market bid and ask prices.

In an embodiment, the traditional trade settlement process can be modified so that trades can execute (i.e., clear) with variable quantities of ad media (measured in impressions or clicks or so on) specified for the commoditized ad units. The tradeable units are, in a sense, futures, i.e., they are guesstimates based on past data on the volume of ad impressions or clicks or conversions that will be available from a source or aggregation of sources in a future time period. The exchange marketplace can classify that traffic but it cannot make the volume predictable. Volume volatility is inherent in the industry, and volatility can increase as classification becomes more granular due to better visibility and discrimination.

Under the prior art, media buyers buy media and then wait for those buys to be fulfilled later with actual traffic. This actual traffic is not always sufficient to fully fulfill the quantity purchased, and the media buyers pay according to actual volume delivered. This is especially true when the media is purchased in a secondary market where other media owners (publishers, as one example) are selling the fraction of media they don't want—i.e., “remnant media.” The exchange marketplace embodying the invention can act as that secondary market. Remnant media is more variable in volume (quantity) than non-remnant.

Traditional exchange models (e.g., stock exchanges) process trades as absolute quantities of products bought or sold, settled within a standard time, for instance three days. The ad exchange marketplace for ad media contemplated by the present invention can settle trades in products that are delivered over time, such that settlement occurs as delivery occurs. For example, at close of each business day, daily delivery statistics can be posted to a settlement ledger that records progress toward complete settlement or fulfillment of all trades.

Accordingly, there can be two types of buy orders identifiable at purchase. One where the buyer specifies a fixed quantity purchased. The other type is where the buyer specifies a ceiling quantity, and he then expects to receive (and pay proportionally for) any quantity from zero to that ceiling quantity.

Billing can be prorated as a percentage of the amount of ad impressions delivered while delivery is ongoing. Trades are executed in advance of the commencement of delivery, and payment is deferred until delivery. As is apparent to a person of ordinary skill in the relevant art, a traditional exchange executing purchases and sales settles right away. Because of the executory nature of the Ad Media, settlement can be separated from the purchase. Thus, settlement must be made over time as delivery is made.

Some embodiments include a method for operating an Internet-based exchange marketplace offering commoditized Ad Media. The identity of Ad Media is received from a publisher for publication of advertisements on a webpage. The Ad Media is automatically classified according to attributes. The classified Ad Media is associated with other classified Ad Media in accordance with predetermined criteria. The associated Ad Media are grouped into buckets forming a predefined quantity of commoditized Ad Media. The commoditized Ad Media are offered for purchase or sale over the Internet as tradeable units on an exchange marketplace.

Embodiments may include one or more of the following features. The predetermined criteria may be at least one of time dependency, geographic location, and demographic information. Business rules may be automatically applied in conjunction with the offering step so as to limit the offering steps to recipients based on the business rules. The business rules may be established as conditions of the purchase or the sale of the tradeable units. The classifying step may occur in real time as ad requests are received. An ad request may be received from an Internet browser accessing a webpage associated with that Ad Media. Advertisements may be routed for display on the webpage based on classifying the ad request, wherein the classification incorporates the attributes. The ad requests may be classified in real time. Purchase of the Ad Media may be settled through at least one of a real time settlement over the Internet and an incrementally updated settlement. Records of the settlement may be stored including purchase and sale information. Records of a plurality of purchasers of the offers to determine the ownership interest in the Ad Media may be queried among the plurality of the purchasers. The ad request may be configured to incorporate purchaser specific information in the ad request. The ad request may be forwarded back to the Internet browser, wherein the Internet browser then accesses an ad server of the purchaser and receives the advertisement. Records of a purchase or sale may be stored. A market accessor tool may be provided to the publisher and a purchaser of the commoditized Ad Media, wherein the market accessor tool accesses the stored records. 11. An ability to utilize the market accessor tool may be provided to monitor the effectiveness of an ad campaign based on data in the stored records. The existence of Ad Media may be dynamically identified conforming to a buyer's preference on the exchange marketplace. An order for Ad Media may be placed on the exchange marketplace. An order present on the exchange marketplace may be cancelled.

An Internet-based exchange marketplace for offering commoditized Ad Media may include the following. A media ownership rules module may contain business rules, wherein the media ownership rules module is in communication with a media trades record module containing records of ownership interests in the commoditized Ad Media; a classification module configured to automatically classify the Ad Media in accordance with predetermined attributes; an ad server registry module containing configuration information specific to a plurality of ad servers; and a tag routing module configured to receive ad requests for advertisements from an Internet browser and forward the ad requests back to the Internet browser for rerouting to an ad server. The tag routing module may access the classification module for categorization of the ad request, obtain an identity of a purchaser of commoditized Ad Media matching the categorized ad request; and configure the ad request based on requirements of the purchaser within the ad server registry module prior to forwarding the ad request back to the Internet browser.

Embodiments may include the following. A market accessor tool may be configured to evaluate the effectiveness of an ad campaign. The market accessor tool may be an interactive GUI, further configured to dynamically identify commoditized Ad Media conforming to a buyer's preference; place an order for the commoditized Ad Media on the exchange marketplace; and cancel an order present on the exchange marketplace.

### II. Online Exchange for Internet Ad Media

A system may bring Advertisers and Publishers together to buy, sell, and manage ad media; as well as manage categorization and delivery of ad requests according to specifications provided by the owning parties.

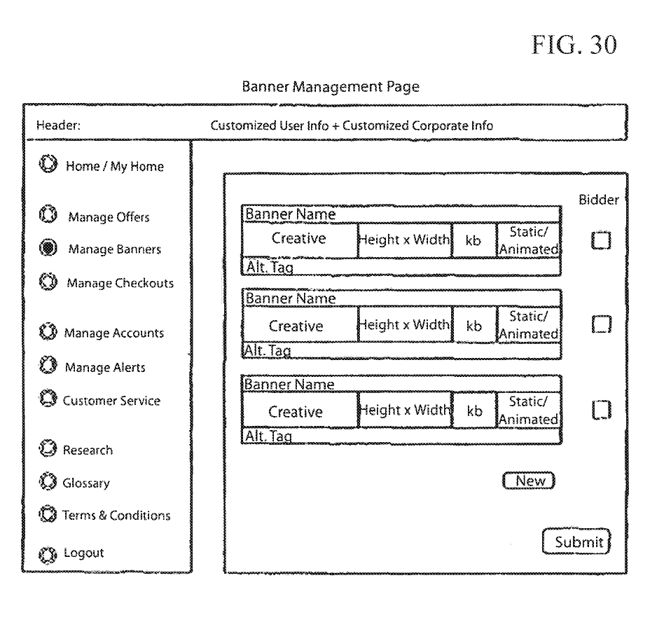

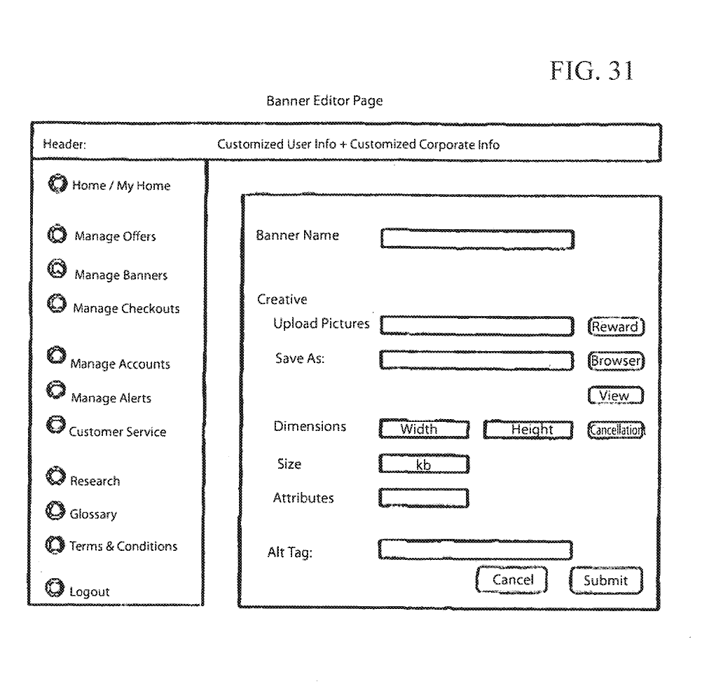

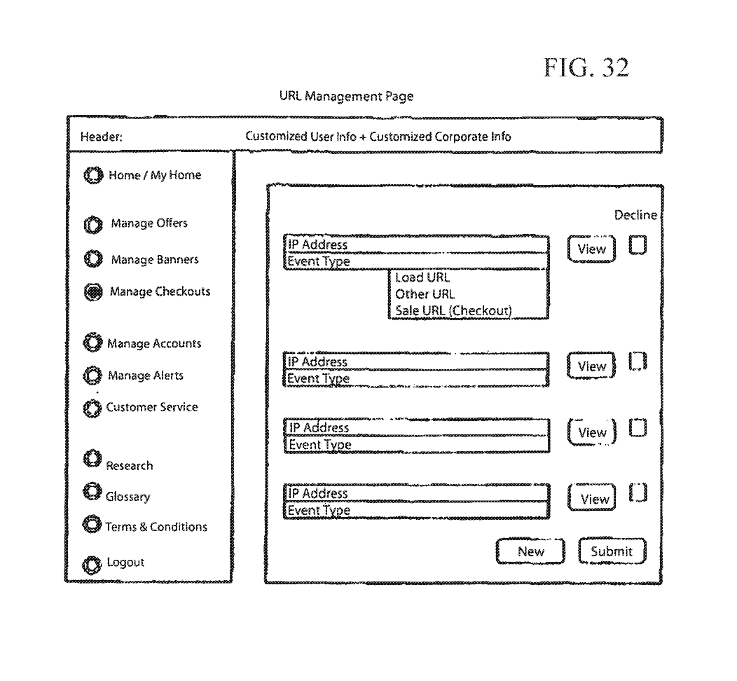

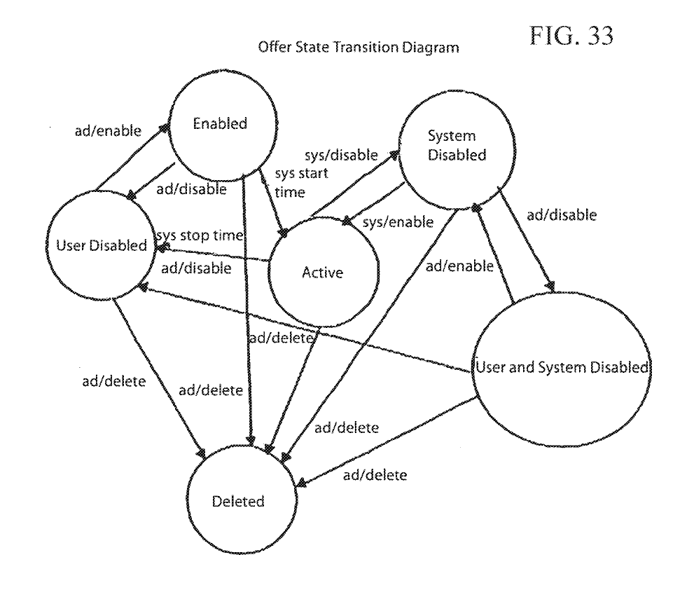

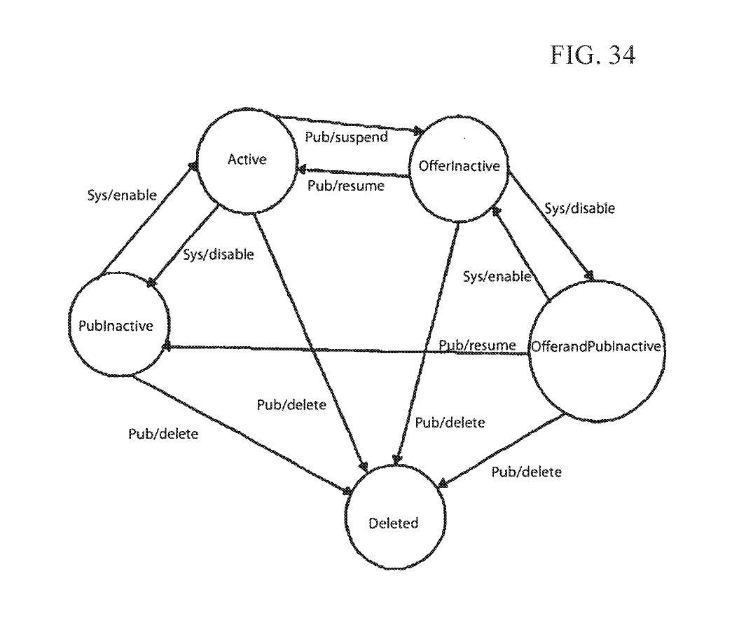

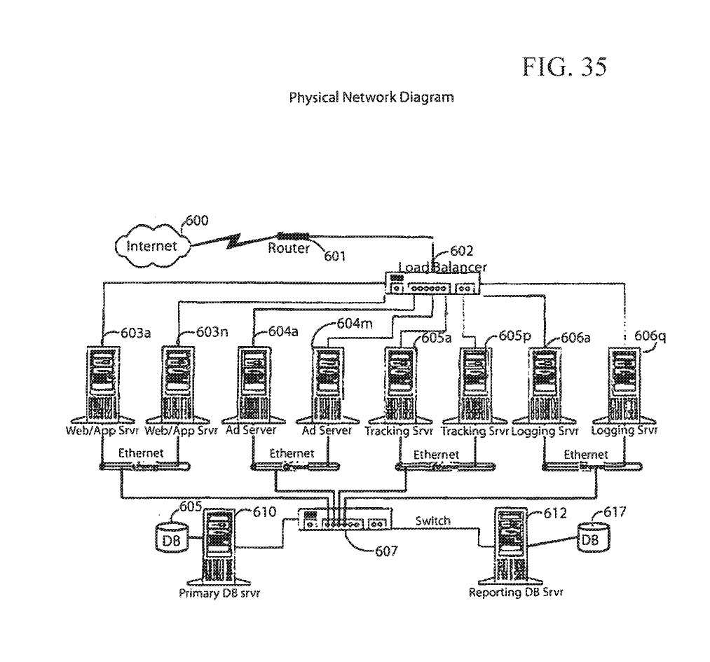

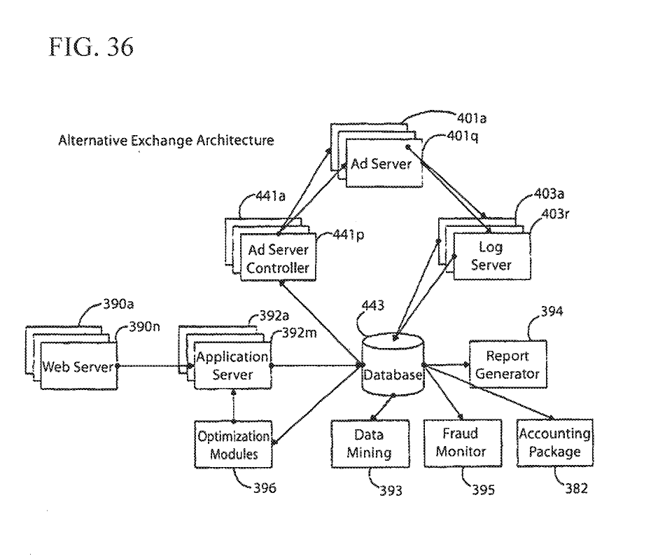

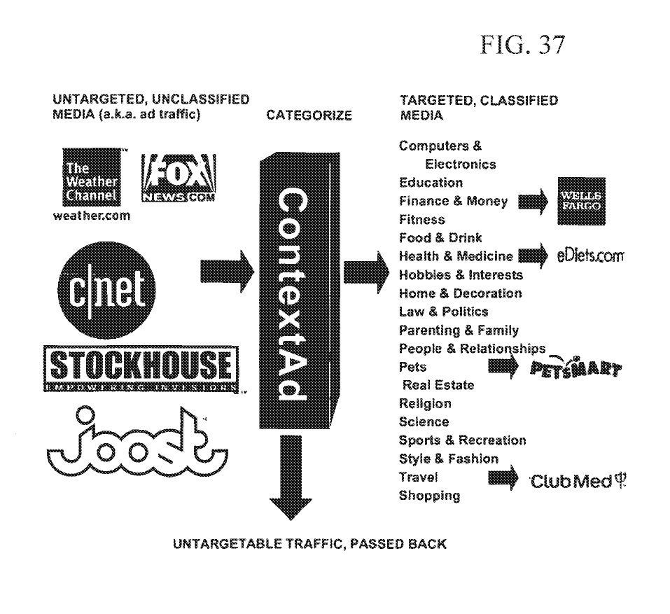

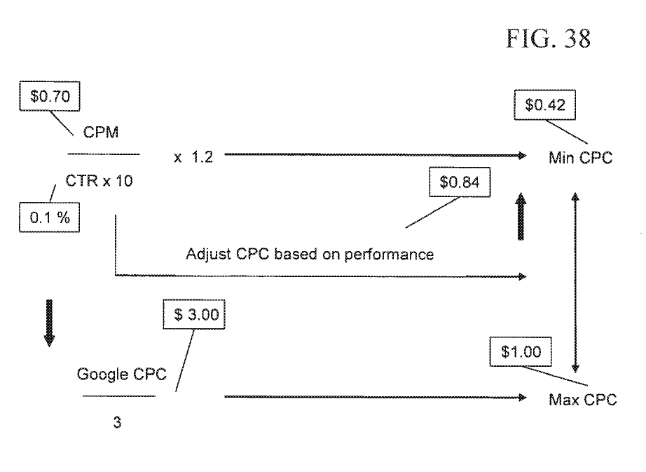

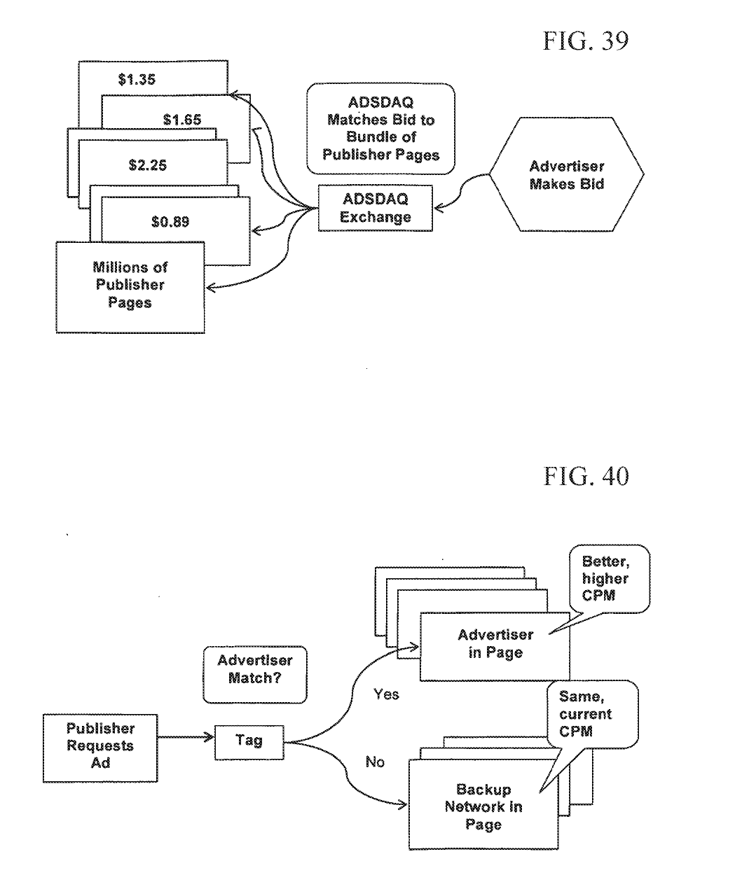

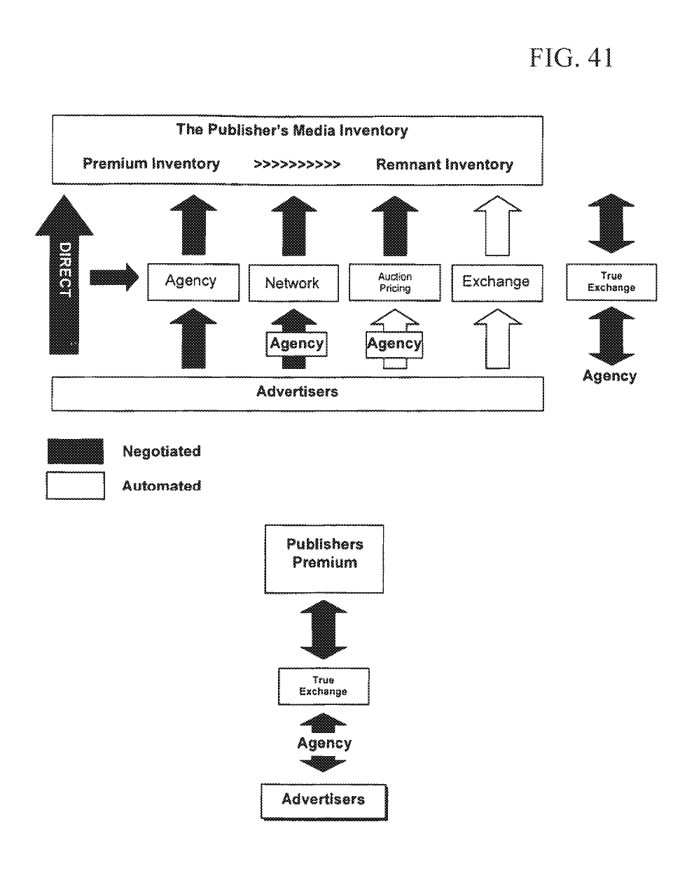

Referring to FIG. 30, a system may provide a standardized exchange where Advertisers and Publishers can meet to buy and/or sell media according to free-market prices and a standard categorization approach. Publishers have advertisement spots to sell for which they choose their AskPrice™. Advertisers aim to match their ads to their desired audience's interests. The exchange receives an impression and categorizes page's content as well as checks which ad campaigns have an acceptable BidPrice™. The exchange checks each ad's performance for pages of this category in this site. Publisher's ad spots sold efficiently so each filled impression is paid guaranteed AskPrice™. Advertiser's ad shown to the most relevant audience at the right price. In summary, both the Advertiser and the Publisher get to name their price, the exchange applies categories to the ad media in real-time page-level categorization, effectively providing true control for publishers and advertisers through the new exchange model.

An online media exchange and method may include:
an exchange system configured to provide a user interface to advertisers and publishers accessing the online media exchange;
a publisher to sell ad spots;
an advertiser with ad campaigns;
   From one or more advertisers, data may be received defining bids to purchase advertising media. From one or more publishers, data may be received defining offers to sell advertising media. A contracting advertiser's bid to purchase may be matched with an offer to sell of respective contracting publishers to form respective contracts. Advertising content including advertising media defined by the contract may be served to consumers accessing websites of the respective publishers. The untargetable or unclassifiable ad media may be passed back when a match is not able to be made to one or more backup ad networks designated by the publisher.

Embodiments may include further features as follows. The online media exchange can be a computer system with an internet server configured to provide a user interface to advertisers and publishers accessing the online media exchange; one or more application servers configured to manage data objects associated with respective advertisers and publishers and further configured to manage online negotiations between advertisers and publishers regarding placement of advertiser ads on publisher websites; a database in communication with the one or more application servers, the database storing data including the data objects; and one or more ad servers in communication with the database, the one or more ad servers configured to serve data defining advertiser ads to publisher websites.

The online media exchange may optionally include one or more application servers configured to manage data objects associated with respective advertisers and publishers and further configured to manage online negotiations between advertisers and publishers regarding placement of advertiser ads on publisher websites. The online media exchange may also optionally include and one or more ad servers in communication with the database, the one or more ad servers configured to serve data defining advertiser ads to publisher websites.

The system may also have the ability to pass back the untargetable or unclassifiable ad media when a match is not able to be made. This ensures that the publisher always receive their asking price, never less than that amount. For instance, if no ads are available at the CPM asking price, then the exchange will send the ad impression to one or more backup ad networks designated by the publisher. Furthermore, there is compatibility with a publisher's existing advertising networks and thus no need for exclusivity. When an advertiser on the exchange cannot deliver the asking price, the exchange will serve ads from the publisher's other designated advertising networks. This always guarantees a better result than ad network alternatives because the publisher sets the asking price and thus set the price of their inventory. They will enjoy a 10-20% higher payout than ad networks are currently paying the publisher because the publisher gets control of their pricing. Furthermore, this feature provides better management of ad trafficking and smart decisions about when to serve the highest paying advertiser.

Beyond being a marketplace for buying and/or selling media and managing owned media, the system 200 also includes a delivery aspect. The exchange technology converts publisher impressions into standardized Contextual Tradable Units™ (CTUs) in real-time. Advertisers can purchase impressions from one or more of the exchange's 344 categories. Thus, the system brokers ad requests generated by media transacted on the marketplace platform by performing real-time categorization of each request. By brokering the request, the system identifies the media buyer who owns the ad request and associates the appropriate Ad Tag (i.e., the Ad Tag registered in the system to that media buyer). This association by the system results in the ad request being routed to the media buyer's desired Ad Server.

Different embodiments interrelate the following elements:
1. A set of publishers, each representing a property, or network of properties, that contains pages where ads may be shown.
2. A set of advertisers, each owning one or more advertisements that the advertiser wishes to have displayed to end users under certain defined conditions.
3. A media marketplace, or exchange, where parties may buy and/or sell media with each other according to free market prices, using standardized, or customized, tools. The exchange taking place on the Internet.
4. An inventory of ad media, comprising a projected quantity of ad requests to be filled as users request and view publisher pages, where the pages contain space available for advertising
5. A tag routing module, which is able to receive, classify (via the classification module) and route ad requests in real time to the ad server(s) specified by media owners.

Other embodiments and implementations of the market accesor tool, consistent with the purpose of empowering users (e.g., traders and other actors in the marketplace) to transact business in the marketplace and to carry out other management and analysis activities related to the marketplace, are within the scope and spirit of the invention. Activities related to the herein described online exchange include, but are not limited to:
1. providing data about responses to the offer from publishers.
2. receiving modifications to the offer or modified offers.
3. receiving ad preference data from a publisher for ads to be hosted by the publisher.
4. storing data about the offers, the bids and matched offers and bids for subsequent retrieval.
5. storing data about event types defined for received offers and bids, storing data about conversion ratios for received offers and bids, storing data about event counts for received offers and bids.
6. detecting and receiving one of revised offer information modifying the data received defining an offer to sell; and revised offer information modifying the data received defining a bid to purchase.
7. detecting and receiving data defining offers to sell comprises receiving from the one or more advertisers information about one or more of creative, a product offer, a flight time, a maximum pay-out amount, a compensation amount, a per click payment amount, a per download payment amount, and a publisher content description.
8. Detecting and receiving data defining bids to purchase comprises receiving from the one or more publishers information about one or more of creative properties, a minimum acceptable incentive level, a minimum effective cost per thousand impressions (CPM), and minimum expected flight duration.
9. matching an offer to sell with one or more bids to purchase comprises: filtering the offer to sell against requirements of the bids of the one or more publishers.
10. reporting to advertisers and publishers data about received offers and received bids.
11. determining an effective cost per thousand impressions (ECPM) for at least one of advertiser offers and publisher bids.
12. determining ECPM as a ratio of value of the advertising media to number of impressions of the advertising content served
13. matching the offer to sell with the one or more bids to purchase by comparing ECPM for the offer to sell with ECPM for the one or more bids.
14. determining past ECPM based on observed activity.
15. determining ECPM based on stored data defining compensation levels for matched offers.
16. determining future ECPM based on observed one of historical event counts and conversion ratios, and current incentive levels.
17. determining future ECPM as a ratio of a predicted value and number of impressions delivered.
18. determining predicted value as a sum of products of current incentive levels and historical event counts over all event types.

An online media exchange may have the following elements. An exchange system is configured to provide a user interface to advertisers and publishers accessing the online media exchange; a publisher to sell ad spots; an advertiser with ad campaigns. The exchange may operate as follows. Receiving from one or more advertisers data defining bids to purchase advertising media; receiving from one or more publishers data defining offers to sell advertising media; matching bid to purchase of a contracting advertiser with an offer to sell of respective contracting publishers to form respective contracts; serving advertising content including advertising media defined by the contract to consumers accessing websites of the respective publishers; and passing back the untargetable or unclassifiable ad media when a match is not able to be made to one or more backup ad networks designated by the publisher.

Specific embodiments may include one or more of the following features. The exchange may have an internet server configured to provide a user interface to advertisers and publishers accessing the online media exchange; one or more application servers configured to manage data objects associated with respective advertisers and publishers and further configured to manage online negotiations between advertisers and publishers regarding placement of advertiser ads on publisher websites; a database in communication with the one or more application servers, the database storing data including the data objects; and one or more ad servers in communication with the database, the one or more ad servers configured to serve data defining advertiser ads to publisher websites. The media exchange may have an ad server controller in communication with the database and the one or more ad servers and configured to convey advertising data from the database to the one or more ad servers. The one or more ad servers may be configured to receive an online request from a consumer, the online request specifying a contracting publisher and an ad; record data regarding the online request; and redirect the consumer to an advertiser website based on data of the request, the advertiser website being associated with a contracting advertiser. The media exchange may have one or more ad servers configured to receive a subsequent request from the consumer, subsequent request including data specifying an action performed by the consumer at the advertiser website; record data regarding the action, the data being recorded in association with contract data linking the contracting advertiser and the contracting publisher. The media exchange may have an accounting package in communication with the database, the accounting package configured to manage billing among the advertisers and the publishers. The media exchange may have a web server is configured to receive an offer from an advertiser. The media exchange may have a web server configured to detect in the offer one or more of creative, a product offer, a flight time, a maximum pay-out amount, a compensation amount, a per click payment amount, a per download payment amount, and a publisher content description. The web server may be is configured to provide data about responses to the offer from publishers. The web server may be configured to receive modifications to the offer or modified offers. The web server may be configured to receive ad preference data from a publisher for ads to be hosted by the publisher. The web server may be configured to detect in the ad preference data one or more of creative properties, a minimum acceptable incentive level, a minimum effective cost per thousand impressions (ECPM), and minimum expected flight duration. The one or more application servers may be configured to match advertiser offers to publishers. The one or more application servers may be further configured to match the advertiser offers to publishers based on a calculated effective cost per thousand impressions. The one or more application servers may be further configured to filter the advertiser offers according to publisher-specified filtering criteria. The one or more application servers may be configured to monitor and log trade transactions between advertisers and publishers. The one or more application servers may be configured to monitor start conditions and termination conditions of trade transactions between advertisers and publishers. The one or more application servers may be configured to determine an effective cost per thousand impressions for trade transactions between advertisers and publishers.

An online media exchange may have a computer system with: means for storing data defining an offer to sell advertising media, the data including data defining a consumer action as a variable input for calculating compensation payable to a publisher for purchase of the advertising media; means for storing data defining an offer to purchase advertising media, the data including data defining a consumer action as a variable input for calculating compensation payable to an advertiser for purchase of the advertising media; means for comparing the data defining an offer to sell advertising media and the data defining an offer to purchase advertising media; means for establishing a contract between an advertiser and a publisher based on the stored data defining an offer to sell advertising media and the stored data defining an offer to purchase advertising media; and means for tracking commissions owed, billed and received under the contract.

Specific embodiments may include one or more of the following features. The media exchange may have means for storing data defining advertising content to be presented in the advertising media; and means for serving the data defining advertising content on the advertising media if the data defining an offer to sell advertising media meets terms of the data defining an offer to purchase advertising media. The media exchange may have means for receiving from an advertiser the data defining an offer to sell advertising media; and means for receiving from a publisher the data defining an offer to purchase advertising media.

An online media exchange may operate as follows. An exchange system is configured to provide a user interface to advertisers and publishers accessing the online media exchange. A publisher sells ad spots. An advertiser has ad campaigns. From one or more advertisers, data are received, the data defining bids to purchase advertising media; from one or more publishers data are received defining offers to sell advertising media. A bid to purchase of a contracting advertiser is matched with an offer to sell of respective contracting publishers to form respective contracts. Advertising content is served, including advertising media defined by the contract to consumers accessing websites of the respective publishers. The untargetable or unclassifiable ad media are passed back when a match is not able to be made to one or more backup ad networks designated by the publisher.

A computer system may be operated as follows. Data are stored, defining an offer to sell advertising media, the data including data defining a consumer action as a variable input for calculating compensation payable to a publisher for purchase of the advertising media. Data are stored defining an offer to purchase advertising media, the data including data defining a consumer action as a variable input for calculating compensation payable to an advertiser for purchase of the advertising media. The data defining an offer to sell advertising media are compared to the data defining an offer to purchase advertising media. A contract is established between an advertiser and a publisher based on the stored data defining an offer to sell advertising media and the stored data defining an offer to purchase advertising media.

Specific embodiments may include one or more of the following. Media may be trafficked in accordance with the contract. 25. The trafficking may include serving banner advertisements created by the advertiser for publication by the publisher. Commission may be based on the contract. The commission may be based on a number of impressions of advertiser creative served. The commission may be based on a number of click-throughs. The commission may be based on a number of leads. The commission may be based on a number of post-click-through actions of a consumer. The commission may be a flat rate commission. The commission may be a percentage rate commission. The commission may be based on data defining the commission received from one of the advertiser and the publisher.

A method for operating an online media exchange may operate as follows. From one or more advertisers data are received defining offers to sell advertising media. From one or more publishers data are received defining bids to purchase advertising media. An offer to sell of a contracting advertiser is matched with one or more bids to purchase of respective contracting publishers to form respective contracts. Advertising content including advertising media defined by the contract is served to consumers accessing websites of the respective publishers.

Specific embodiments may include one or more of the following. Data about the offers, the bids and matched offers and bids are stored for subsequent retrieval. Data about event types defined for received offers and bids, data about conversion ratios for received offers and bids, and data about event counts for received offers and bids may be stored. One of revised offer information modifying the data received defining an offer to sell; and revised offer information modifying the data received defining a bid to purchase, may be received. 3Receiving data defining offers to sell may include receiving from the one or more advertisers information about one or more of creative, a product offer, a flight time, a maximum pay-out amount, a compensation amount, a per click payment amount, a per download payment amount, and a publisher content description. Receiving data defining bids to purchase may include receiving from the one or more publishers information about one or more of creative properties, a minimum acceptable incentive level, a minimum effective cost per thousand impressions (CPM), and minimum expected flight duration. Matching an offer to sell with one or more bids to purchase may include filtering the offer to sell against requirements of the bids of the one or more publishers. Data about received offers and received bids may be reported to advertisers and publishers. An effective cost per thousand impressions (ECPM) may be determined for at least one of advertiser offers and publisher bids. The ECPM may be determined as a ratio of value of the advertising media to number of impressions of the advertising content served. Matching the offer to sell with the one or more bids to purchase may include comparing ECPM for the offer to sell with ECPM for the one or more bids. ECPM may be determined based on observed activity. Determining past ECPM may be based on stored data defining compensation levels for matched offers. Determining future ECPM may be based on observed one of historical event counts and conversion ratios, and current incentive levels. Future ECPM may be determined as a ratio of a predicted value and number of impressions delivered. Predicted value may be determined as a sum of products of current incentive levels and historical event counts over all event types.

A method for trading advertising media may proceed as follows. An exchange data structure may be provided accessible via a communications network. In the data structure may be stored data defining an offer to sell advertising media, the data defining a selling compensation scheme which uses a consumer action as a variable input to calculate compensation payable to purchase the advertising media. In the data structure may be stored data defining an offer to purchase advertising media, the data defining a purchasing compensation scheme which uses a consumer action as a variable input to calculate compensation payable to purchase the advertising media. The offer to sell and the offer to purchase may be compared to identify whether the offer to purchase meets the terms of the offer to sell.

Specific embodiments may include one or more of the following. Data may be stored defining advertising content to be presented in the advertising media, and the advertising content data may be published on the advertising media if the offer to purchase meets the terms of the offer to sell. The consumer action may be measured. The effective cost per thousand for the offer to purchase or the offer to sell may be computed, and the effective cost per thousand output. The offer to purchase may be revocable at will.

A method for publishing information on the current market value of media may proceed as follows. An exchange data structure may be provided accessible via a communications network; In the data structure may be stored data defining an offer to sell advertising media, the data defining a selling compensation scheme which uses a consumer action as a variable input to calculate compensation payable to purchase the advertising media. In the data structure may be stored data defining an offer to purchase advertising media, the data defining a purchasing compensation scheme which uses a consumer action as a variable input to calculate compensation payable to purchase the advertising media. The data defining an offer to purchase or the data defining an offer to sell may be published.

A system for trading advertising media may proceed as follows. An exchange data structure may be provided accessible via a communications network. In the data structure may be stored data defining an offer to sell advertising media, the data defining a selling compensation scheme which uses a consumer action as a variable input to calculate compensation payable to purchase the advertising media. In the data structure may be stored data defining an offer to purchase advertising media, the data defining a purchasing compensation scheme which uses a consumer action as a variable input to calculate compensation payable to purchase the advertising media. Means to compare the offer to sell and the offer to purchase may identify whether the offer to purchase meets the terms of the offer to sell.

Specific embodiments may include one or more of the following. Data defining advertising content to be presented in the advertising media may be stored. Means for publishing the advertising content data on the advertising media if the offer to purchase meets the terms of the offer to sell. The consumer action may be measured. A calculator for calculating the effective cost per thousand for the offer to purchase or the offer to sell, and an output for outputting the effective cost per thousand. The offer to purchase may be revocable at will.

A system for publishing information on the current market value of media may include the following. An exchange data structure may be accessible via a communications network. In the data structure may be stored data defining an offer to sell advertising media, the data defining a selling compensation scheme which uses a consumer action as a variable input to calculate compensation payable to purchase the advertising media. In the data structure may be stored data defining an offer to purchase advertising media, the data defining a purchasing compensation scheme which uses a consumer action as a variable input to calculate compensation payable to purchase the advertising media. Publishing means may publish the data defining an offer to purchase or the data defining an offer to sell.

III. Open Insertion Order System to Interface with an Exchange for Internet Ad Media

While publishers and advertisers are users of the system embodying the present invention, an end-user is the target of the advertising and is typically an individual accessing a web page and reading its content and advertisements.

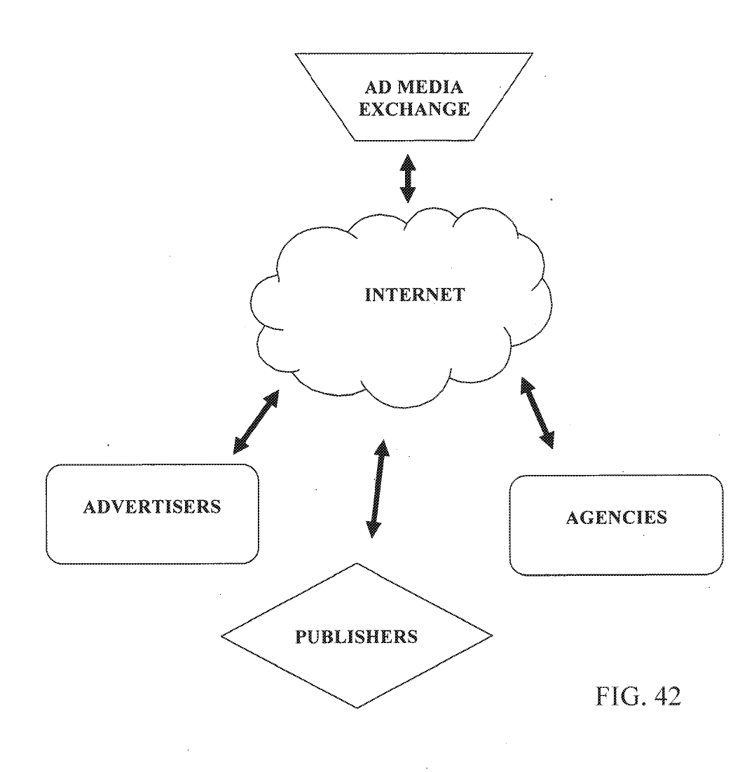

As depicted in FIG. 42, an online exchange system for trading ad media consists of a website linked to a central computer (ad media exchange server) connected to a computer network (in this case the Internet), databases and an information system based on applications for networked computers, where the interaction of advertisers, agencies and publishers is allowed for exchanges of ad media in advertising campaigns. The system is based mainly on a website on the Internet that is connected to the main computer (server) and store functions and administers access of other remote computers (media traders) through the website.

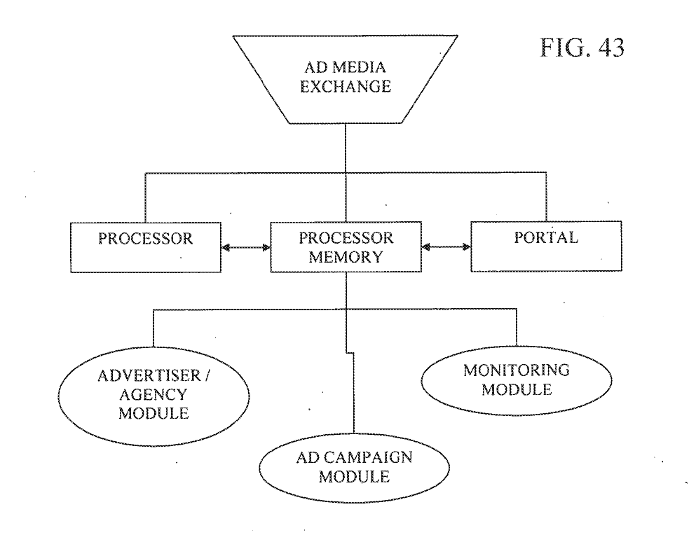

Generally, the fundamental parts of this system are the advertisers, agencies, publishers, and the ad media exchange system. As illustrated in FIG. 43, the ad media exchange system includes the following subsystems: a processor; Internet exchange portal, and processor memory. The memory stores several modules that help facilitate the actions of the exchange. These modules include an advertiser or agency module; an ad campaign module; and a monitoring module. The advertiser or agency module is related to advertisers or agencies buying media from a publisher. The ad campaign module is related to establishing an ad campaign in an ad server. The monitoring module is responsible for monitoring an ad campaign delivery and for automatically filling in a delivery shortfall of media buys of the campaign with media inventory from exchange. Additional modules (not shown) are provided for ad media classification, accessing information, tag routing, transacting business and pricing.

The Internet exchange portal interacts with the modules of the system for the exchange of campaign delivery information.

The modules of exchange are composed of computer programs necessary to guarantee the perfect operation of the exchange system, to assure confidentiality of the data contributed by the participants, as well as the correct application of its service demands offered by the system, and to obtain what is required to maintain (sign up, modifications, unsubscribe) the general parameters of the system, interfaces with banks and forms of collections, data mining, utilities, anti-virus, anti-spyware, anti-hackers, report, registration of participants, agreements, regulations, e-mail and general services of aid and benefits to users, among others.

A marketplace may allow parties to buy, sell, and manage ad media; as well as manage categorization and delivery of ad requests according to specifications provided by the respective owning parties (e.g., publisher or advertiser or agents thereof).

Different embodiments encompass the following elements:
1. A set of publishers, each representing a property (i.e., advertising space on a webpage), a network, an aggregation of properties, that contains pages where ads may be shown.
2. A set of advertisers and/or agencies, each owning one or more advertisements that the advertiser wishes to have displayed to end-users under certain defined conditions.
3. An ad media exchange marketplace (herein referred to as “exchange marketplace or “exchange” interchangeably and without differentiation), where parties may buy and/or sell media with each other according to free market prices, using standardized or customized tools.
4. An available Ad Budget translated into a required inventory of ad media to fill that budget based on the payment method. If the payment for the ad inventory is on a CPM (“Cost Per Thousand”) basis, the required inventory to fill the budget is a projected quantity of ad requests to be filled as users request and view publisher pages, where the pages contain space available for advertising. (If advertiser is buying on CPC (“Cost Per Click”), the quantity to fill is the number of clicks the ad receives. If they buy on a CPA (“Cost Per Action”), the quantity is the number of conversions)
5. A set of media traders (e.g., media buyers and/or sellers), each able to transact media purchases and sales on the marketplace of the present invention.
6. A media classification module, which is operable to perform real-time classification of the ad requests comprising the inventory of ad media. The module is implemented in hardware, software, or a combination thereof, and is operative in a computer-based Internet capable system.
7. A set of media “buckets,” each comprising a part of the complete ad media inventory managed by the system, where each bucket contains a quantifiable inventory of media. Each member of the ad media inventory has the same properties (e.g., such as page category, publisher site, time of day or month or year, and geographic location of the end-user), or a subset thereof being a constituent of the bucket.
8. A set of market accessor tools, each such tool enabling its user to perform a combination of: 1) transacting business (e.g., placing buy and sell orders) on the marketplace embodying the present invention; 2) viewing available media buckets, their properties, quantity available, and current market prices; and 3) viewing and managing media currently owned by that user or the party he represents. Additional information and tools may also be provided by these tools such as detailed status of executed trades that are currently partially fulfilled. By way of example, if the trader has executed and cleared a buy order for up to one million impressions in a particular media bucket to be delivered during the month of May 2008, on May 10th the market accessor tool can show partial delivery and prorated charges according to ad requests routed to his ad server by the exchange during the first 10 days of the month. The market accessor tool can be implemented as hardware, software or a combination of hardware and software.
9. A tag routing module able to receive, classify (via the classification module) and route ad requests in real time to the ad server(s) specified by media owners.

The preferred embodiment of the present invention is a method for supporting open insertion order (“10”) operations for online advertising markets. FIG. 42 is a flowchart diagram that depicts this method. This method is predicated on media exchange activity that takes place between buyers and sellers of ad media on the marketplace of the Internet.

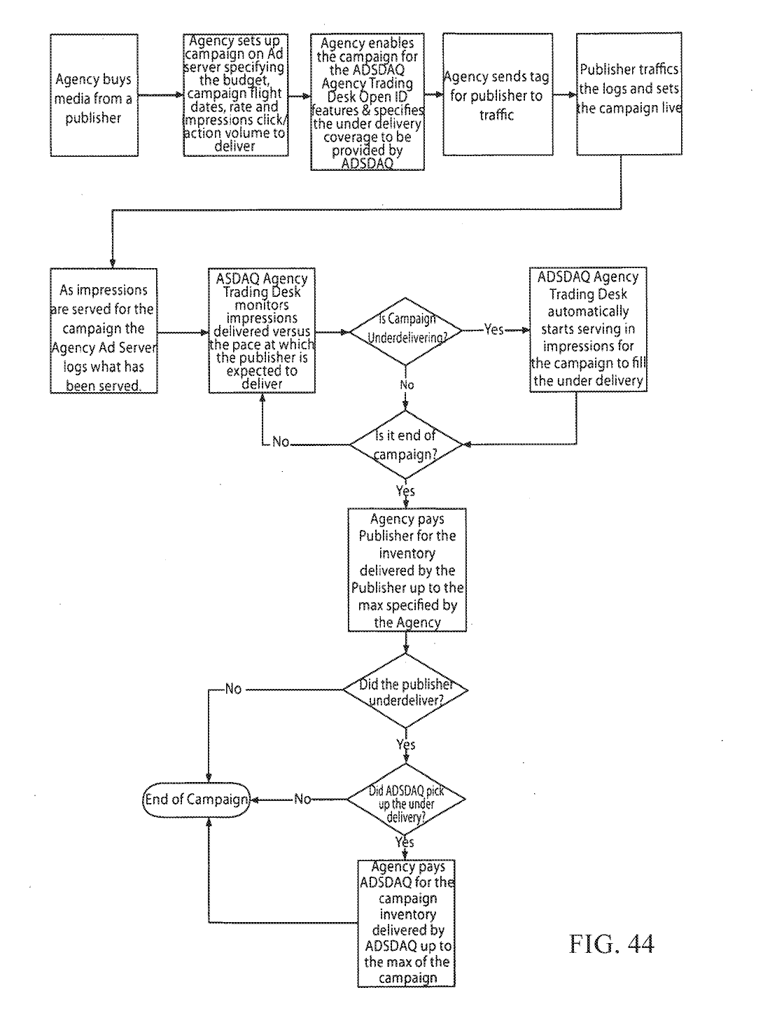

Standard producers of online ad-request inventory are publishers. They own or operate websites that users visit using web browsers, and they allocate space on those pages where advertisements may be added. Consumers of online ad-request inventory are Advertisers. They offer products or services online, and they create advertisements for those offerings which they desire to show to Internet users. Those advertisements are then added into the publishers' pages so that users see them as they browse. Each time an individual user browses to a publishers' page that contains pre-allocated space for advertising, an Ad Request to deliver an ad to fill that allocated space can be made to an Ad Server either by the user's browser or by the Publisher. As depicted in the flowchart of FIG. 44, the exchange is initiated when Agency purchases media from a publisher.

The Agency can then set up campaign on an Ad server specifying the budget, campaign flight, dates, rates and impression/click action volume to deliver. When the ad media is considered in terms of the number of expected ad requests, the inventory is typically quantified as a particular number of Ad Impressions. Ad Impressions are priced as a CPM. Additionally, because a click may or may not result each time an ad is shown to a user, inventory may also be quantified as a particular number of expected Ad Clicks, and could be priced as a CPC. Inventory also may be quantified and priced in other standard ways known to those in the relevant art, such as a number of Conversions and a CPA which measures the advertising cost per users who purchase or subscribe to the advertised product or service.

The next step in the exchange process involves the Agency enabling the campaign for the exchange Agency Trading Desk Open IO feature. At this step the degree of under delivery coverage to be provided by exchange is specified. FIG. 43 demonstrates this step, wherein the Agency will specify the percentage of under delivery to be covered by the exchange. The Agency will also specify the type of inventory to be utilized to cover the inventory. For example, the Agency can specify that the under delivery should be filled with ad inventory on pages about travel read by users in the United States.

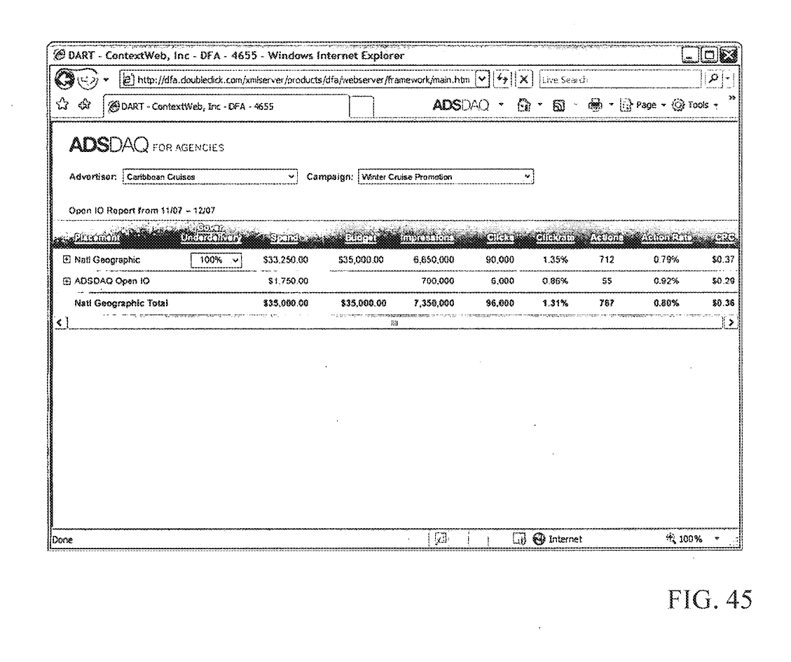

FIG. 45 is a screenshot illustrating an example wherein the Agency has purchased inventory from National Geographic for demonstration purposes of this application. As shown in the screenshot, the Agency will indicate in the drop down option named “Cover Under Delivery” how much of National Geographic's budget can be utilized by the exchange to cover National Geographic's under delivery. This can be a range from 0-100%. For example, assume the Agency specifies that 10% of National Geographic's Budget can be utilized by the exchange to fulfill any under delivery by National Geographic. Assume the budget to be run by National Geographic is $30,000. Given this scenario, the exchange can fill up to $3,000 worth of under delivery. So, as the campaign runs, the present invention will monitor the pace of delivery by National Geographic. If the pace is trending for National Geographic to deliver $28,000 worth of media, the exchange will run $2,000 worth of media to fill the under delivery to reach the total budget of $30,000. If National Geographic is trending to deliver only $25,000 of inventory, the exchange will deliver the max allocated of $3,000 to fill the under delivery. In this scenario, only $28,000 of the total $30,000 available budget will be delivered. In another Scenario, assume National Geographic starts the campaign trending to delivery only $25,000 and the exchange backfills with the maximum $3,000 worth of inventory. Then, towards the end of the campaign, National Geographic catches up and delivers $28,000 worth of inventory. In this case, the exchange will only invoice the Agency $2,000 of under delivery and will not charge the $1,000 of excess delivery over the target budget of $30,000. In this scenario, the full $30,000 of available budget was spent. This is only for illustrative purposes. This invention can be embodied in a variety of other ways where the Agency can specify a maximum dollar budget that can be utilized to cover the under delivery instead of a percentage of overall budget. The Agency will also be able to specify other parameters of the type of inventory that can be used to fulfill the under delivery. These parameters include targeting items such as geographic targeting, frequency caps, content of the pages the ad is delivered on, time of day, day of week and many others. This targeting allows the Agency to model the inventory used to fill the under delivery of a certain publisher to be as similar as possible to the publishers original inventory. So for example, if the Agency bought media from a travel publisher like National Geographic, then the Agency can specify that the under delivery should be filled with “travel pages” on the exchange.

Then the Agency sends the small piece of industry-standard software called an Ad Tag for the publisher to traffic. The Agency specifies to the Publisher how the Ad Tag should be executed in the contracted terms of the sale, i.e., user geographic locations, time of day, specified date range (“flight dates”), quantity, and other parameters.

The Publisher then traffics the tags and sets the campaign live as per the terms specified by the Agency. As impressions, clicks and actions are served for the campaign, the Agency Ad Server logs what has been served and the amount of budget that has been spent. This is critical for the exchange Agency Trading Desk monitor being able to then monitor impressions, clicks and actions delivered versus the pace at which the publisher is expected to deliver.

Therefore, it must be determined if the campaign is under delivering. If the campaign is not under delivering, then the campaign proceeds until the campaign is to be terminated. If the campaign is not pacing to deliver the target budget, then the exchange Agency Trading Desk automatically starts serving impressions for the campaign to fill the under delivery. This process continues with exchange Agency Trading Desk monitoring the impressions, clicks, actions delivered versus the pace at which the publisher is expected to deliver until the campaign has reached its completion. Missing from the prior art models is the mechanism and assurance that enables advertisers and agencies who make a media buy to fulfill their advertising budget completely. Thus, the monitoring of the campaign delivery and the automatic delivery of additional impressions from the exchange to cover the under delivery, satisfies the long-felt need of ensuring complete delivery of advertising inventory so an agency can bill the client for the budget in its entirety.

Once the campaign has reached the end of its campaign, the Agency pays the Publisher for the inventory delivered by the Publisher. Payment is made up to the maximum specified by the Agency. If the publisher under delivered, then the Agency pays the publisher for the amount delivered by the Publisher. If exchange did pick up the under delivery, then the agency pays the exchange for the campaign inventory delivered by the exchange up to the maximum of the campaign budget.

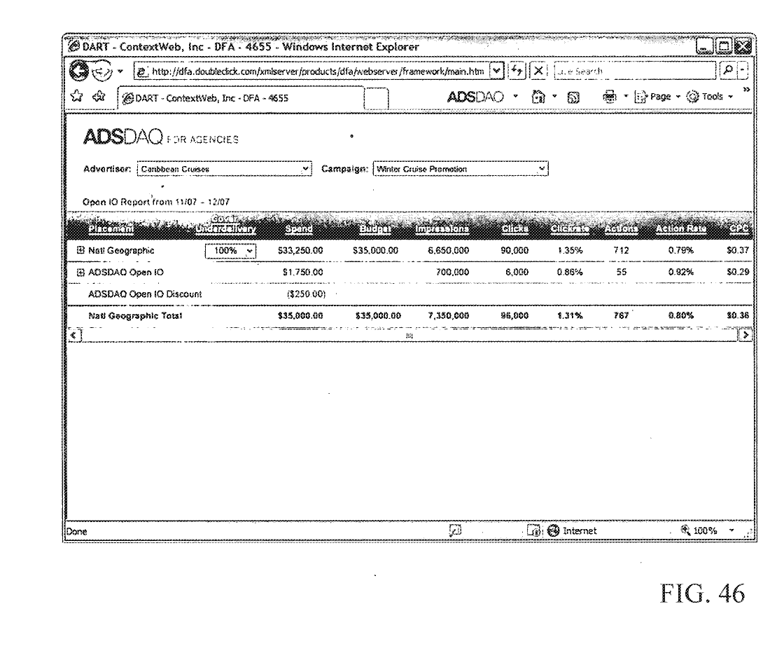

FIG. 46 is a screenshot illustrating an example wherein if the Agency representing National Geographic catches up towards the end of the campaign, the exchange will not charge for any delivery above the placement budget. As exhibited in FIG. 44, the Open IO Discount is $250.00 which indicates the amount that the exchange will not charge the Agency. This amount of insurance or risk that the exchange will provide is based on an algorithm that one of skill in the art could generate and implement.

A method for trading ad media implemented on a server having access to the Internet may proceed as follows. An Internet exchange portal may enable media trader stations to access the server over the Internet, the Internet exchange portal being configured to enable media traders to buy, sell, and manage ad media via the media trader stations.

Particular embodiments may include the following features. An advertiser or agency may buy ad media from a publisher. One or more of the advertiser or agency and the publisher may register with the server via the Internet exchange portal. The advertiser or agency may set up a campaign in an ad server. The ad server may be connected to the exchange to monitor and automatically fulfill a delivery shortage for the campaign via the Internet exchange portal. The server may monitor the campaign delivery and automatically fill in the delivery shortfall of other media buys of the advertisers campaigns with media inventory from exchange, and wherein if the shortfall of media buys are recovered before the end date of the campaign, the server may charge no fee from the agency or advertiser for the media.

An exchange system for trading ad media may be implemented on a server having access to the Internet, with the following components. A processor, an Internet exchange portal enabling advertisers, agencies and publishers to access the server over the Internet; and a processor memory accessible to the processor. The he processor memory may include administration information modules related to advertisers or agencies buying media from a publisher; administration information modules related to establishing an ad campaign in an ad server; and administration information modules that monitor an ad campaign delivery and automatically fill in a delivery shortfall of media buys of the campaign with media inventory from exchange.

Specific embodiments may include one or more of the following features. The Internet exchange portal may interact with the modules of the system for the exchange of campaign delivery information. The campaign delivery may be monitored by a media classification module which performs real-time classification of the ad requests comprising the inventory of ad media. A set of media buckets may each include a part of the complete ad media inventory managed by the system, where each bucket contains a quantifiable inventory of media. A set of market accessor tools may enable a user to perform one or more functions selected from transacting business on the exchange, viewing available media buckets, and viewing and managing media currently owned by that user or represented party. A set of market accessor tools may enable a user to view a detailed status of executed trades that are currently partially fulfilled. A tag routing module may receive, classify and route ad requests in real time to an ad server specified by the media trader. If the shortfall of media buys are recovered before the end date of the campaign, the server may charge no fee to the agency or advertiser for the media.

A method implemented on a server for operating an exchange for Internet ad media may include the following steps: receiving ad campaign information for an advertiser from an ad agency server indicating a campaign budget, ad request information, a campaign duration, and a number of delivered ad impressions for the campaign; determining whether the number of impressions delivered indicates an under delivery condition for impressions allocated according to the campaign budget; and when an under delivery condition is indicated, performing the additional steps of: determining a number of impressions required to clear the under delivery condition; determining a media type for the required impressions as a function of the ad request information; querying an ad exchange to determine whether an inventory of impressions is available for the determined media type; and, when an inventory of impressions for the determined media type is available, acquiring a number of impressions from the inventory for the ad campaign that is no greater than the required number of impressions.

Specific embodiments may include one or more of the following features. 1The server may forward ad tag information for the campaign to one or more publishers for delivering the acquired impressions. The ad request information may indicate a maximum portion of the budget to be applied for the acquired impressions. Updated ad campaign information for the advertiser may be received from the ad agency server indicating an updated number of delivered ad impressions for the campaign; and a discount fee amount for the advertiser may be determined when the updated number of delivered ad impressions and a delivered number of the acquired impressions exceed the campaign budget.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein. Use of absolute terms, such as “will not,” “will,” “shall,” “shall not,” “must,” and “must not,” are not meant to limit the present invention as the embodiments disclosed herein are merely exemplary.

### CONCLUSION

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the present invention may be implemented in hardware, software, a combination of the two, as well as in one or more computer websites executing on electronic devices such as personal digital assistants (PDAs) and programmable computers. Each device should include a processor, a storage medium readable by the processor (including volatile and non-volatile memory and/or storage elements), at least one input device and one or more output devices. The output information is applied to one or more output devices.

The invention claimed is:

1. A method, comprising the steps of:
by an exchange computer system, receiving supply data from one or more internet publishers, the supply data specifying media space to be supplied to content providers for delivery of the providers' content at future times by respective supplying publishers and compensated in per-delivery charges as respective supplying publishers deliver the providers' content over the internet, and storing the supply data into the memory of the exchange computer;
by the exchange computer system, receiving request data from one or more content providers, the request data specifying requests to acquire internet space for subsequent display of the providers' content, and storing the request data into the memory of the exchange computer; and
by the exchange computer system, matching the request data against the supply data to form respective contracts between respective publishers and content providers for delivery of the providers' content, the contracts specifying serving of the providers' content to be provided by respective contracting content providers over internet media provided by the contracting publishers, and compensation in per-delivery charges as contracted publishers deliver the contracted content providers' content over the internet.

2. The method of claim 1, further comprising the step of:
by the exchange computer system, managing online negotiations between content providers and publishers regarding placement of the providers' content on publisher websites.

3. The method of claim 1, further comprising the step of:
for media space supplied by publishers, and that cannot be matched to the request data of content providers, passing back supplied media space to the supplying publisher.

4. The method of claim 1, further comprising the step of:
on receipt of an online request from a consumer, the online request specifying a contracting publisher's web site, directing delivery of content from a contracted content provider based on the user's request and a contract between the requested publisher and a respective one of the content providers.

5. The method of claim 1, further comprising the step of:
on receiving a request from a consumer, the request specifying an action performed by the consumer at the website of a contracting content provider, recording data in association with data describing the contract between the contracting content provider and the contracting publisher to be used in computing compensation for the contracting publisher.

6. The method of claim 1, further comprising the step of:
computing accounting information to be used in billing among the content providers and the publishers.

7. The method of claim 1, further comprising the step of:
by the exchange computer system, receiving modifications from publishers to modify supply data provided by the publisher.

8. The method of claim 1, further comprising the step of:
by the exchange computer system, receiving data from publishers describing preferences for ads to be hosted by the publisher.

9. The method of claim 8, further comprising the step of:
filtering the supply data before matching based at least in part on publisher-specified filtering criteria.

10. The method of claim 1, further comprising the step of:
matching request data against supply data based at least in part on a calculated effective cost per thousand impressions.

11. A computer system, comprising:
a processor;
a memory, having stored therein one or more programs programmed to cause the computer to:
receive supply data from one or more internet publishers, the supply data specifying media space to be supplied to content providers for delivery of the providers' content at future times by respective supplying publishers and compensated in per-delivery charges as respective supplying publishers deliver the providers' content over the internet, and to store the supply data into the memory of the exchange computer;
receive request data from one or more content providers, the request data specifying requests to acquire internet space for subsequent display of the providers' content, and to store the request data into the memory of the exchange computer; and
match the request data against the supply data to form respective contracts between respective publishers and content providers for delivery of the providers' content, the contracts specifying serving of the providers' content to be provided by respective contracting content providers over internet media provided by the contracting publishers, and compensation in per-delivery charges as contracted publishers deliver the contracted content providers' content over the internet.

12. The computer system of claim 11, the programs further programmed to cause the computer to:
manage online negotiations between content providers and publishers regarding placement of the providers' content on publisher websites.

13. The computer system of claim 11, the programs further programmed to cause the computer to:
for media space supplied by publishers, and that cannot be matched to the request data, to pass the supplied media space back to the supplying publisher.

14. The computer system of claim 11, the programs further programmed to cause the computer to:
on receipt of an online request from a consumer, the online request specifying a contracting publisher's web site, direct delivery of advertising from a contracted content provider based on the user's request and a contract between the requested publisher and a respective one of the content providers.

15. The computer system of claim 11, the programs further programmed to cause the computer to:
on receiving a request from a consumer, the request specifying an action performed by the consumer at the website of a contracting content provider, record data in association with data describing the contract between the contracting content provider and the contracting publisher to be used in computing compensation for the contracting publisher.

16. The computer system of claim 11, the programs further programmed to cause the computer to:
compute accounting information to be used in billing among the content providers and the publishers.

17. The computer system of claim 11, the programs further programmed to cause the computer to:
receive modifications from publishers to modify supply data received from the publisher.

18. The computer system of claim 11, the programs further programmed to cause the computer to:
receive data from publishers describing preferences for ads to be hosted by the publisher.

19. The computer system of claim 18, the programs further programmed to cause the computer to:
filter the supply data before matching based at least in part on publisher-specified filtering criteria.

20. The computer system of claim 11, the programs further programmed to cause the computer to:
match the supply data against the request data based at least in part on a calculated effective cost per thousand impressions.
